(19) United States
(12) Patent Application Publication
(10) Pub. No.: US 2011/0156853 A1
(43) Pub. Date: Jun. 30, 2011

(54) REACTOR-USE COMPONENT AND REACTOR

(76) Inventors: Masayuki Kato, Osaka (JP); Takuji Kanto, Osaka (JP); Atsushi Ito, Osaka (JP); Shinichiro Yamamoto, Osaka (JP); Hajime Kawaguchi, Osaka (JP); Kazuhiko Nii, Osaka (JP)

(21) Appl. No.: 13/060,229

(22) PCT Filed: Aug. 14, 2009
(86) PCT No.: PCT/JP2009/003898

§ 371 Date: Feb. 22, 2011

(30) Foreign Application Priority Data
Aug. 22, 2008 (JP) 2008-214068

(51) Int. Cl. H01F 27/29; H01F 30/00

(52) U.S. Cl. 336/192; 336/221

(57) ABSTRACT

A reactor-use component which provides improved workability in assembling into a reactor, and a reactor using the component are provided. The reactor-use component is for structuring a reactor including a coil 10 formed with a pair of paralleled coil elements 10A and 10B made of a spirally wound wire and a core 20 fitted into the coil elements 10A and 10B to form an annular shape. The reactor-use component includes an internal resin portion 30 that retains a shape of the coil 10, and hollow bores 30h formed by a part of the internal resin portion 30 for fitting the core 20 to inner circumferences of the coil elements 10A and 10B. By inserting internal core portions 22 into the hollow bores 30h and joining opposite ends of the internal core portions 22 to exposed core portions 24, the reactor 1 can be obtained. Because the internal resin portion 30 retains the coil 10 in a state incapable of expanding or compressing, the workability in assembling into the reactor 1 can be improved.

### TECHNICAL FIELD

The present invention relates to a reactor used as a component of a converter or the like, and to a reactor-use component structuring the reactor.

### BACKGROUND ART

In hybrid vehicles having been gaining popularity in recent years, a converter that boosts up and steps down a voltage is used. One known component of the converter is a reactor disclosed in Patent Document 1.

The main constituents of the reactor are an annular core made of a magnetic material, and a coil formed of a wound wire such as a rectangular wire. In assembling the reactor, for example, the rectangular wire is previously wound edgewise, to form a pair of coil elements. The pair of coil elements are coupled in parallel to each other by a couple portion. Then, into inner circumferences of the coil elements, internal core portions made up of a plurality of core pieces and gap members are fitted. Thereafter, two end faces of the internal core portions are coupled to each other on exposed core portions exposed outside the coil elements, to form the annular core.

In the assembling, between the coil and the core, a resin-made sleeve-like bobbin is interposed for positioning the coil relative to the core. At either end of the coils, a resin-made frame-like bobbin is disposed. Normally, the coil before being assembled into a reactor has a clearance between adjacent turns, which is attributed to springback of the rectangular wire. Accordingly, the coils having been assembled have their opposite ends held by the frame-like bobbins, so as to establish a compressed state where the adjacent turns are brought into contact with each other.

### CITATION LIST

### Patent Literature

Patent Document 1: Japanese Unexamined Patent Publication No. 2008-28290, FIGS. 3 and 4

### SUMMARY OF INVENTION

### Technical Problem

However, the conventional technique described above suffers from a problem of poor assembling workability because the number of components of the reactor is great.

Specifically, positioning of the core and the coil necessitates preparation of the sleeve-like bobbin as a separate component. Normally, such a sleeve-like bobbin is formed into a sleeve-like shape by combining a pair of split pieces each having a square bracket-shaped cross section. Hence, the assembling work thereof is additionally required.

Further, when there is a clearance between each adjacent turns of the coils, the coils expand and compress. This makes it difficult to handle the coils in assembling steps. On the other hand, the frame-like bobbin as a separate component is required for retaining the coil in a compressed state, and hence the assembling work of the frame-like bobbin to the coil (core) is additionally required.

The present invention is made in consideration of the aforementioned circumstances, and one object thereof is to provide a reactor-use component with which a reduction in the number of components can be achieved, and a reactor using the component.

Another object of the present invention is to provide a reactor-use component being excellent in workability when being assembled into a reactor, and a reactor using the component.

Still another object of the present invention is to provide a reactor-use component which facilitates formation of a terminal block for connecting an external device for supplying the wire with power to the ends of the wire, and a reactor using the component.

Still another object of the present invention is to provide a reactor-use component which realizes easier formation of a place for accommodating a sensor for measuring any physical quantity that varies in accordance with an operation of a reactor, such as temperature variations of the reactor, and a reactor using the component.

Still another object of the present invention is to provide a reactor-use component capable of reducing a projected area of a reactor, and a reactor using the component.

Still another object of the present invention is to provide a reactor-use component which can minimize a projection portion in a coil axial direction, and a reactor using the component.

Still another object of the present invention is to provide a reactor-use component exhibiting an excellent heat dissipation characteristic, and a reactor using the component.

Still another object of the present invention is to provide a reactor-use component which provides greater flexibility as to an installation place of a terminal block to the coils, and a reactor using the component.

### Solutions to Problem

A reactor-use component of the present invention is a reactor-use component for structuring a reactor including a coil formed with a pair of paralleled coil elements made of a spirally wound wire and a core fitted into the paired coil elements to form an annular shape. The component includes an internal resin portion that retains a shape of the coil, and hollow bores formed by a part of the internal resin portion for fitting the core to inner circumferences of the coil elements.

With this structure, because the coil can be retained in a state incapable of expanding or compressing by the internal resin portion, the coil can easily be handled. Further, by fitting the core into the hollow bores of the reactor-use component, the reactor can easily be structured.

The reactor-use component of the present invention further includes internal core portions being part of the core, the internal core portions being inserted into the hollow bores and being integrated with the internal resin portion. The internal core portions have their respective opposite ends exposed outside the internal resin portion.

With this structure, because the coil is retained in a state incapable of expanding or compressing by the internal resin portion, and the internal core portions being a part of the core are also integrated with the coil, the part of the core and the coil can easily be handled as a single component. Further, the internal resin portion is capable of functioning as a bobbin (a sleeve-like bobbin and a frame-like bobbin) in conventional reactors. Therefore, it is not necessary to prepare a separate bobbin, or to carry out assembling work of the bobbin to the core. Still further, joining the exposed core portions to end faces of the internal core portions of the reactor-use component, the resultant component can function as a reactor.

The reactor-use component of the present invention further includes terminal fittings each connected to an end of the wire, the terminal fittings being integrated by molding of the internal resin portion.

With this structure, the terminal fittings connected to the ends of the wire can integrally be formed by molding of the internal resin portion, to structure a terminal block. Consequently, no mounting member for integrating the terminal block with the core and the coil is required. Therefore, an external device for supplying the coil with power can easily be connected to the terminal fittings of the terminal block.

In the reactor-use component of the present invention, a sensor-use hole for accommodating a sensor for measuring a physical quantity of the reactor is formed by molding in the internal resin portion.

With this structure, a sensor such as a temperature sensor for measuring the temperature of the coil can easily be disposed near the coil simply by inserting the sensor into the sensor-use hole. Further, because the sensor-use hole is formed in the internal resin portion by molding, no separate step such as cutting work for forming such a sensor-use hole is required. Consequently, the coil and the core will not be damaged by any cutting tool which may otherwise be used for forming the sensor-use hole.

In a case where the reactor-use component of the present invention further includes terminal fittings being integrated by molding of the internal resin portion, the reactor-use component further includes a nut accommodating hole that is formed by molding of the internal resin portion and that has a polygonal cross section, and a nut that has a polygonal outer shape and that is accommodated in the nut accommodating hole. The terminal fittings each have an insertion hole for a bolt to be screwed with the nut. The terminal fittings are each bent to thereby overhang an opening of the nut accommodating hole so as to allow the bolt to be inserted through an insertion hole and to be screwed with the nut, and to thereby prevent the nut from coming off from the nut accommodating hole.

With this structure, a terminal block that includes the terminal fittings and the nut can easily be formed. In particular, because the nut is not integrated by molding of the internal resin portion, the resin structuring the internal resin portion will not intrude inside the nut when the internal resin portion is molded. On the other hand, because a part of each terminal fitting overhang the opening of the corresponding nut accommodating hole, the nut can surely be prevented from coming off.

In the reactor-use component of the present invention, the coil is structured with a continuous wire, and includes a couple portion coupling the paired coil elements to each other, and the couple portion projects toward an outside of a turn portion of the coil elements relative to a turn-formed face formed by the turn portion.

With this structure, because the couple portion coupling the pair of coil elements to each other projects toward the outside relative to the turn-formed face of the coil, of the entire core surface, the top and bottom faces of the exposed core portions and the top and bottom faces of the internal core portions may not necessarily be flush with each other. As a result, in a case where a core whose volume is equivalent to that of a conventional reactor is to be manufactured, a projected area of the reactor can be reduced by increasing a height of the exposed core portions exposed outside the coil and reducing an exposed width (i.e., a coil axial length) of the exposed core portions than those of the conventional reactor.

In the reactor-use component of the present invention, the coil is structured with a continuous wire, and includes a couple portion coupling the paired coil elements to each other. The couple portion is disposed between the paired coil elements without projecting in the height direction relative to the paired coil elements. The coil elements have their respective spiral progressing directions arranged so as to be opposite to each other's. Here, in the coil elements, an axial direction of each of the coil elements starting from the ends of the wire structuring the coil element toward the couple portion is defined as the spiral progressing direction of each of the coil elements, and a direction perpendicular to both a paralleled direction of the coil elements and the axial direction of each of the coil elements is defined as the height direction of the coil.

With this structure, because the coil elements have their respective spiral progressing directions arranged so as to be opposite to each other's, and the couple portion coupling the coil elements to each other extends across the coil axis direction while not projecting in the height direction of the coil relative to the coil elements, the bend radius of the bent portion occurring in the couple portion can be increased greater than that can be seen in the conventional ones. As a result, insulation coating of the wire at the couple portion becomes less prone to be damaged. Even when the wire is increased in diameter, the insulation coating of the wire becomes less prone to be damaged. Further, because the couple portion is positioned between the paired coil elements, the couple portion projects little in the axial direction of the coil elements.

In a case where the reactor-use component of the present invention is used as a constituent of a reactor, a heatsink integrated with the internal resin portion is provided to an install face of the reactor-use component facing a reactor fixation target.

With this structure, provision of the heatsink at the install face of the reactor-use component makes it possible to dissipate heat of the core and the coil via the heatsink effectively toward the install face. Further, integration of the heatsink and the coil by the internal resin portion provides a single component with which the heatsink is equipped. This facilitates handling of the component when manufacturing the reactor.

In the reactor-use component of the present invention, the ends of the wire structuring the coil elements are led out sideways from the coil elements.

With this structure, the ends of the wire being led out sideways from the coil elements enhance the flexibility of disposition of the terminal block connected to the wire ends. It is to be noted that, in another mode, the case for accommodating the assembled product made up of the coil and the core can be dispensed with. In this mode, dispensing with use of the case realizes miniaturization of the reactor.

Meanwhile, a reactor of the present invention includes a coil formed with a pair of paralleled coil elements made of a spirally wound wire and a core fitted into the paired coil elements to form an annular shape. The reactor further includes an internal resin portion that retains a shape of the coil, and hollow bores formed by a part of the internal resin portion for fitting the core to inner circumferences of the coil elements. The core includes internal core portions fitted into the hollow bores and exposed core portions that are integrated with the internal core portions and that are exposed outside the hollow bores.

With this structure, because the internal resin portion can retain the coil in a state incapable of expanding or compressing, the coil can easily be handled. Further, because the core is fitted into the hollow bores of the reactor-use component, the reactor can easily be manufactured.

In the reactor of the present invention, the internal core portions are integrated with the internal resin portion.

With this structure, because the coil is retained in a state incapable of expanding or compressing by the internal resin portion, and the internal core portions being a part of the core are also integrated with the coil, a part of the core and the coil can easily be handled as a single component. Further, the internal resin portion is capable of functioning as a bobbin (a sleeve-like bobbin and a frame-like bobbin) in conventional reactors. Therefore, it is not necessary to prepare a separate bobbin, or to carry out the assembling work of the bobbin to the core.

The reactor of the present invention further includes an external resin portion that integrates the core and the internal resin portion.

With this structure, the external resin portion can fully mechanically protect not only the coil and the internal resin portion, but also the core. In particular, it is possible to structure a reactor that does not employ a metal-made case, which makes it possible to reduce the reactor in size.

In a case where the reactor of the present invention further includes the internal resin portion and the external resin portion, the exposed core portions of the core are each made of a powder magnetic core (i.e. pressurized powder compact of soft magnetic core). Defining a face of each of the constituents of the reactor facing the reactor fixation target as an install face, the install face of the internal resin portion and the install faces of the exposed core portions are both exposed outside the external resin portion and are flush with each other.

With this structure, because the exposed core portions are each formed of a powder magnetic core, the core having a complicated three-dimensional shape can easily be structured. Further, a reactor in which both the install face of the internal resin portion and the install faces of the exposed core portions are exposed outside the external resin portion, while being flush with each other, can easily be structured. Consequently, it becomes possible to bring the install face of the internal resin portion and the install faces of the exposed core portions into contact with the reactor fixation target, whereby a reactor exhibiting high heat dissipation characteristic can be obtained.

In a case where the reactor of the present invention further includes the internal resin portion and the external resin portion, a resin structuring the internal resin portion is higher in heat conductivity than a resin structuring the external resin portion, and the resin structuring the external resin portion is higher in shock resistance than the resin structuring the internal resin portion.

With this structure, use of the resin exhibiting a high heat conductivity for the internal resin portion and use of the resin being excellent in shock resistance for the external resin portion make it possible to structure a reactor having both the excellent heat dissipation characteristic and excellent mechanical characteristic.

In a case where the reactor of the present invention further includes the internal resin portion and the external resin portion, the internal resin portion is structured with a resin containing a ceramic filler.

With this structure, because the resin contains the ceramic filler, the heat conductivity of the internal resin portion can further be enhanced, and it becomes possible to structure a reactor having an excellent heat dissipation characteristic.

In a case where the reactor of the present invention further includes the internal resin portion and the external resin portion, the reactor further includes terminal fittings each connected to an end of the wire, the terminal fittings being integrated by molding of the external resin portion.

With this structure, the terminal fittings each connected to an end of the wire can be integrated by molding of the external resin portion, to thereby structure a terminal block. Consequently, no mounting member for integrating the terminal block with the core and the coil is required. An external device for supplying the coil with power can easily be connected to the terminal fittings of the terminal block.

In a case where the reactor of the present invention further includes the internal resin portion and the external resin portion, a sensor-use hole for accommodating a sensor for measuring a physical quantity of the reactor is provided at the external resin portion.

With this structure, a sensor can easily be disposed near the coil simply by inserting the sensor into the sensor-use hole. Further, because the sensor-use hole is formed in the external resin portion by molding, no separate step such as cutting work for forming such a sensor-use hole is required. Consequently, the coil and the core will not be damaged by any cutting tool which may otherwise be used for forming the sensor-use hole.

In a case where the reactor of the present invention further includes the internal resin portion and the external resin portion, and the sensor-use hole is provided at the external resin portion, the sensor-use hole is provided at the external resin portion at a portion that covers between the coil elements.

With this structure, the sensor can be disposed between the paired coil elements, which makes it possible to substantially equally detect the physical quantities of the respective coil elements. In particular, the sensor can be disposed between the coil elements where heat tends to build up. Thus, the temperature of the reactor can efficiently and correctly be measured.

In a case where the reactor of the present invention further includes the internal resin portion, the external resin portion, and the terminal fittings integrally formed by molding of the external resin portion, the reactor further includes a nut accommodating hole that is formed by molding of the external resin portion and that has a polygonal cross section, and a nut that has a polygonal outer shape and that is accommodated in the nut accommodating hole. The terminal fittings each have an insertion hole for a bolt to be screwed with the nut. The terminal fittings are each bent to thereby overhang an opening of the nut accommodating hole so as to allow the bolt to be inserted through the insertion hole and to be screwed with the nut, and to thereby prevent the nut from coming off from the nut accommodating hole.

With this structure, a terminal block that includes the terminal fittings and the nut can easily be formed. In particular, because the nut is not integrated by molding of the external resin portion, the resin structuring the external resin portion will not intrude inside the nut when the external resin portion is molded. On the other hand, because a part of each terminal fitting overhang the opening of the corresponding nut accommodating hole, the nut can surely be prevented from coming off.

In the reactor of the present invention, the coil is structured with a continuous wire, and includes a couple portion coupling the paired coil elements to each other, and the couple portion projects toward an outside of a turn portion of the coil elements relative to a turn-formed face formed by the turn portion.

With this structure, because the couple portion coupling the pair of coil elements to each other projects toward the outside relative to the turn-formed face of the coil, of the entire core surface, the top and bottom faces of the exposed core portions and the top and bottom faces of the internal core portions may not necessarily be flush with each other. As a result, in a case where a core whose volume is equivalent to that of a conventional reactor is to be manufactured, a projected area of the reactor can be reduced by increasing a height of the exposed core portions exposed outside the coil and reducing an exposed width (i.e., a coil axial length) of the exposed core portions than those of the conventional reactor.

In the reactor of the present invention, the coil is structured with a continuous wire, and includes a couple portion coupling the paired coil elements to each other. The couple portion is disposed between the paired coil elements without projecting in the coil height direction relative to the paired coil elements. The paired coil elements have their respective spiral progressing directions arranged so as to be opposite to each other's. Here, in the coil elements, an axial direction of each of the coil elements starting from the ends of the wire structuring the coil element toward the couple portion is defined as the spiral progressing direction of each of the coil elements, and a direction perpendicular to both a paralleled direction of the coil elements and the axial direction of each of the coil elements is defined as the height direction of the coil.

With this structure, because the paired coil elements have their respective spiral progressing directions arranged so as to be opposite to each other's, and the couple portion coupling the paired coil elements to each other extends across the coil axis direction while not projecting in the height direction of the coil relative to the paired coil elements, the bend radius of the bent portion occurring in the couple portion can be increased greater than that can be seen in the conventional ones. As a result, an insulation coating of the wire at the couple portion becomes less prone to be damaged. Even when the wire is increased in diameter, the insulation coating of the wire becomes less prone to be damaged. Further, because the couple portion is positioned between the paired coil elements, the couple portion projects little in the axial direction of the paired coil elements.

In a case where the reactor of the present invention further includes the internal resin portion and the external resin portion, the exposed core portions of the core are each made of a powder magnetic core. A face of each of constituents of the reactor facing a reactor fixation target is defined as an install face. The reactor further includes a heatsink integrated with the install face of the internal resin portion, and the install face of the heatsink and the install faces of the exposed core portions are both exposed outside the external resin portion and are flush with each other.

With this structure, provision of the heatsink at the install face of the reactor realizes efficient heat dissipation. Further, because the install face of the heatsink and the install faces of the exposed core portions are both exposed outside the external resin portion and are flush with each other, both the heatsink and the exposed core portions can be brought into contact with the fixation target. This contributes to enhancing the heat dissipation characteristic.

In the reactor of the present invention, the ends of the wire structuring the coil elements are led out sideways from the coil elements.

With this structure, the ends of the wire being led out sideways from the coil elements enhance the flexibility of disposition of the terminal block connected to the wire ends. It is to be noted that, in another mode, the case for accommodating the assembled product made up of the coil and the core can be dispensed with. In this mode, dispensing with use of the case realizes miniaturization of the reactor.

In a case where the reactor of the present invention further includes the internal resin portion and the external resin portion, the reactor further includes a case for accommodating an assembled product obtained by integrating the coil provided with the internal resin portion and the core. The external resin portion is formed with a potting resin injected between the case and the assembled product.

With this structure, use of the case achieves full protection of the core and the coil, and the potting resin achieves an enhancement of the heat conduction to the case from the assembled product. Thus, a reactor having an excellent heat dissipation characteristic can be obtained.

In a case where the reactor of the present invention further includes the internal resin portion and the external resin portion, the external resin portion includes a flange portion that projects outside an assembled product obtained by integrating the coil provided with the internal resin portion and the core. The flange portion is provided with a bolt hole for a bolt for fixing the reactor to a fixation target.

With this structure, the reactor can be fixed to the fixation target by use of the bolt hole at the external resin portion.

In a case where the reactor of the present invention further includes the bolt hole for the bolt for fixing the reactor to a fixation target provided at the flange portion molded with the external resin portion, the bolt hole has a metal pipe that is integrated by molding of the external resin portion.

With this structure, the bolt hole can be reinforced by the metal pipe, whereby occurrence of any damage to the flange portion can be suppressed.

### Advantageous Effects of Invention

With the reactor-use component of the present invention, because the internal resin portion retains the coil in a state incapable of expanding or compressing, the workability in assembling into a reactor can be improved.

Further, the reactor of the present invention can be assembled easily.

### BRIEF DESCRIPTION OF DRAWINGS

FIG. 1 shows a reactor according to Embodiment 1 of the present invention, in which (A) is a top-side perspective view and (B) is a transparent perspective view.

FIG. 2 is a bottom-side perspective view of the reactor according to Embodiment 1 of the present invention.

FIG. 3 is an exploded perspective view showing an assembly procedure of the reactor according to Embodiment 1 of the present invention.

FIG. 4 is a transparent side view showing an attached state of terminal fittings in the reactor according to Embodiment 1.

FIG. 5 is an explanatory illustration showing a molding method of a reactor-use component used for the reactor according to Embodiment 1 of the present invention.

FIG. 6 shows a reactor-use component according to Embodiment 2-1 of the present invention, in which (A) is a perspective view and (B) is a plan view.

FIG. 7 is a perspective view showing an assembled state of a coil and internal core portions of the reactor-use component according to Embodiment 2-1 of the present invention.

FIG. 8 is an explanatory illustration showing a molding method of the reactor-use component according to Embodiment 2-1 of the present invention.

FIG. 9 is an exploded perspective view showing an assembly procedure of a reactor according to Embodiment 2-1 of the present invention.

FIG. 10 is a rear view showing a reactor-use component according to Embodiment 2-2 of the present invention.

FIG. 11 is a perspective view of a reactor-use component according to Embodiment 2-3 of the present invention.

FIG. 12 shows a reactor according to Embodiment 3 of the present invention, in which (A) is a transparent perspective view as seen from a top face, and (B) is a perspective view as seen from a bottom face.

FIG. 13 is a perspective view of a coil used in a reactor according to Embodiment 4.

FIG. 14 is four orthogonal views of the coil shown in FIG. 13, in which: (A) is a front view (as seen in Y2 direction in FIG. 13); (B) is a left side view; (C) is a plan view; and (D) is a rear view.

FIG. 15 is a perspective view showing the coil shown in FIG. 13 in course of manufacture.

FIG. 16 is four orthogonal views of the coil in course of manufacture shown in FIG. 15, in which: (A) is a front view (as seen in Y2 direction in FIG. 15); (B) is a left side view; (C) is a plan view; and (D) is a rear view.

FIG. 17 is a perspective view of a coil used in a reactor according to Embodiment 5-1.

FIG. 18 is a perspective view of a coil used in a reactor according to Embodiment 5-2.

FIG. 19 is a perspective view of a coil used in a reactor according to Embodiment 5-3.

FIG. 20 is a perspective view of a coil used in a reactor according to Embodiment 5-4.

FIG. 21 is a perspective view of a coil used in a reactor according to Embodiment 5-5.

FIG. 22 is a perspective view of a coil used in a reactor according to Embodiment 5-6.

FIG. 23 is a perspective view of a coil used in a reactor according to Embodiment 5-7.

FIG. 24 is a perspective view of a coil used in a reactor according to Embodiment 6.

FIG. 25 is a side view showing a disposed state of terminal fittings and an internal resin portion in a reactor according to Embodiment 7.

FIG. 26 is an explanatory illustration of an assembly procedure of a reactor according to Embodiment 8.

FIG. 27 is a transparent perspective view of a reactor according to Reference Example 1.

FIG. 28 is a transparent side view of the reactor according to Reference Example 1.

FIG. 29 shows a reactor according to Reference Example 2, in which (A) is a perspective view, and (B) is a perspective view where an external resin portion is removed from the reactor.

FIG. 30 is a perspective view of terminal fittings used in the reactor according to Reference Example 2.

FIG. 31 shows a reactor according to Reference Example 3, in which (A) is a transparent perspective view, and (B) is a cross-sectional view.

### MODES FOR CARRYING OUT THE INVENTION

### Overview

A reactor-use component of the present invention includes a coil and an internal resin portion, and further includes internal core portions in some cases. As used herein, the former may also be referred to as a coil molded product, and the latter may also be referred to as a core integrated type coil molded product. The reactor of the present invention further includes one of; (1) an assembled product made up of a coil molded product, internal core portions and exposed core portions; and (2) an assembled product of a core integrated type coil molded product and the exposed core portions. As necessary, the reactor of the present invention further includes at least one of an external resin portion and a case in addition to each of the assembled products. Further, terminal fittings may be integrated with the coil by molding of at least one of the internal resin portion and the external resin portion, to form a terminal block. Such constituents will be described in more detail below. Note that a reactor is basically structured with a core and a coil. Accordingly, a reactor can be structured by combining this basic structure and one of or any number of the following technical matters (which include descriptions of the present section, Embodiments, and Reference Examples).

### [Reactor-Use Component]

### <Coil>

The coil is structured by a wire being wound in a spiral manner, the wire being made up of a conductor and an insulation coating that coats circumference of the conductor. A typical example of the coil is a pair of paralleled coil elements, in which wire portions of respective coil elements are each electrically connected via a couple portion. As the conductor, a metal material that exhibits an excellent conductivity, such as copper (copper alloy), may preferably be employed. As the insulation coating, enamel or the like may preferably be employed.

The couple portion may be structured with a continuous wire being bent so as to couple the pair of coil elements to each other. Alternatively, the pair of coil elements may be prepared from separate wires, and respective one ends of the wires may directly be connected to each other by welding or the like or may indirectly be connected to each other having an appropriate conductive member interposed therebetween. In particular, in a case where the couple portion is structured with the bent continuous wire, it is preferable that the couple portion projects toward at least one of upward and downward relative to a turn-formed face formed by a turn portion of the coil elements.

When the couple portion is disposed at one of the exposed core portions at its face (e.g., a top face) opposite to an install face for the reactor, a mounting member for fixing the core to a reactor fixation target may be interposed between the couple portion and the opposite face. The mounting member includes, for example, a pair of leg pieces to be fixed to a fixation target, and a couple piece coupling the leg pieces to each other. Fixation of the reactor should be carried out by use of the mounting member such that the couple piece holds the face of each exposed core portion opposite to the install face, while the paired leg pieces are positioned at either side of the exposed core portion. In this case, when the reactor is seen two-dimensionally, the couple portion, the couple piece of the mounting member, and the exposed core portion are overlaid on one another, thereby enabling a contour shape of the reactor to be smaller.

In a case of the coil in which a continuous wire is bent and the pair of coil elements is coupled by a couple portion, the couple portion may be disposed between the coil elements. A manufacturing method of such a coil may be: a method of manufacturing a reactor-use coil member including one coil element and the other coil element disposed in parallel to each other and a couple portion coupling the coil elements to each other, the foregoing components are made of a single wire, the method including the following steps (A) to (D). In such a case, a direction along a coil winding axis of each of the coil elements starting from ends of the wire structuring the coil elements toward the couple portion is defined as a spiral progressing direction of the coil, and a direction perpendicular to both the paralleled direction of the coil elements and the coil axis direction is defined as a height direction of the coil elements.

(A) A step of preparing a single wire.

(B) A step of winding one end of the wire to form one coil element.

(C) A step of winding the other end of the wire keeping an interval from the one coil element by a length for preparing a couple portion to form the other coil element, such that following requirements are satisfied:
(1) an axial direction of the other coil element is substantially in parallel to an axial direction of the one coil element; and
(2) a height direction position of the other coil element is substantially aligned with that of the one coil element.

(D) A step of bending the couple portion such that the couple portion does not project in the height direction of the coil elements, and parallel the coil elements such that their respective spiral progressing directions are opposite to each other's.

More specifically, the step (C) of forming the other coil element may be carried out such that the following requirements are satisfied:

(1) the other coil element is positioned on the axially opposite side to the side of the one coil element with reference to the couple portion; and

(2) the spiral progressing direction of the other coil element is opposite to the spiral progressing direction of the one coil element.

In a case where the other coil element is formed such that the above requirements (1) and (2) are satisfied, the step of paralleling the coil elements should be carried out such that the couple portion is disposed between the coil elements.

The coil obtained through such a method has a greater bend radius of the wire corresponding to the couple portion than that of the conventional one, and therefore the lead or the insulation coating of the wire is less likely to be damaged during production.

The cross section of the wire may be any one of various modes such as circular, oval, and polygonal. The coil structured with a wire having a polygonal cross section provides a greater space factor as compared to a coil structured with a wire having a circular cross section. In a case where a wire whose cross section is rectangular, edgewise winding may preferably be adopted as a method of winding the wire. At a stage where the coil is formed by the wire a clearance is normally formed between the turns of the coil, which is attributed to springback of the conductor material. An axial length of the coil in an uncompressed state is defined as a free length of the coil. On the other hand, it is also possible to employ a coil free of springback which has substantially no clearance between the turns.

### <Internal Resin Portion>

The internal resin portion covers at least a part of the coil and retains the shape of the coil. The internal core portion, whose description will be given later, may also be integrated with the coil by the internal resin portion. The internal resin portion may, as long as it retains the shape of the coil, cover entirely the turn portion of the coil, or it may partially cover the turn portion of the coil to leave the rest of the turn portion exposed outside the internal resin portion. Further, the internal resin portion may retain the coil in a compressed state to be shorter than its free length, or it may retain the coil shape in its free length. In the former case, the coil molded product can be reduced in coil axial length. In particular, when the coil is in a compressed state where the adjacent turns of the coil are brought into contact with each other, the reactor-use component can further be miniaturized. In the latter case, when the coil molded product or the core integrated type coil molded product is to be molded, it is not necessary to compress the coil to be shorter than its free length. This also makes it possible to employ a mold of a simplified structure. Further, because a clearance is formed between the adjacent turns of the coil, the space between the turns is filled with the resin structuring the internal resin portion, whereby insulation between the turns can more fully be secured. In either case, the reactor-use component can be handled as a single member that does not expand or compress by springback of the coil. Thus, handleability of the components in assembling into a reactor can be improved. Further, a frame-like bobbin employed conventionally for holding the coil can be dispensed with. However, because the ends of the wire structuring the coil must be connected to terminal fittings, the ends should be exposed outside the internal resin portion. Led-out position of the ends of the wire is not particularly limited. The ends of the wire can be led out in any appropriate direction, e.g., in the top face direction, side face directions, or end face direction of the reactor, in consideration of clearances between the reactor and the peripheral devices at the site where the reactor is to be installed.

The internal resin portion functions to position the internal core portions relative to the coil (the coil elements). Accordingly, preferably, the cross-sectional shape of each hollow bore formed inside the coil by the internal resin portion corresponds to the cross-sectional shape of the internal core portion, and thickness of the internal resin portion formed between the coil and the internal core portions is substantially uniform. Thus, the internal core portions and the coil are substantially coaxially combined. It goes without saying that the internal resin portion formed at an inner circumference of the coil contributes toward securing the insulation between the core and the coil. Accordingly, with the reactor-use component of the present invention, the conventionally used sleeve-like bobbin can be dispensed with. The smaller thickness of the internal resin portion formed between the coil and the internal core portions is preferable in view of heat dissipation performance. For example, it may be about 2 mm.

Further, the internal resin portion may be provided with convex and concave portions at a portion corresponding to an outer circumference of the coil. The convex and concave portions increase surface area of the reactor-use component, which brings about an improvement in the heat dissipation performance. Further, in a case where an assembled product being a combination of the reactor-use component and the exposed core portions is covered by the external resin portion, the concave portion formed by the convex and concave portions can be used as a flow channel of the external resin portion, such that the external resin portion can smoothly flow through the circumference of the reactor-use component. For example, a groove extending along an open-close direction of the mold employed in molding the internal resin portion may be formed at the outer circumferential face of the internal resin portion. Depth of the groove is not particularly limited. The coil may be exposed outside the internal resin portion, or the coil may be covered by the internal resin portion. In the former case, an enhanced heat dissipation performance can be expected; in the latter case, a part of the coil where the groove is formed can also be protected mechanically and electrically. However, a case or a cooling base, which is the fixation target of the assembled product made up of the coil and the core or the fixation target of the reactor, is normally structured with a flat face. Therefore, in order to secure an area in contact with the case or the cooling base, an install face that is a part of the internal resin portion and that faces the case or the like may not be provided with the groove and may be formed as a flat face.

As resin structuring the internal resin portion, what can suitably be used is a material that is heat resistant so as not to be softened when the maximum temperature of the coil (core) is reached in a case where the reactor-use component is used as a reactor, and that can undergo transfer molding or injection molding. Further, a material that exhibits excellent insulation is preferable. For example, a thermosetting resin such as epoxy, or a thermoplastic resin such as polyphenylene sulfide (PPS) or liquid crystal polymer (LCP) resin can suitably be used.

In a case where the reactor is structured with the assembled product made up of the coil molded product, the internal core portions and the exposed core portions, or the assembled product made up of the core integrated type coil molded product and the exposed core portions, the assembled products may be covered by the external resin portion. In such a case, while the internal resin portion can be made of the same material as that of the external resin portion, it is more preferable that the internal resin portion is made using a resin that exhibits higher heat conductivity than the external resin portion does; and it is preferable to use a resin for the external resin portions a resin that is superior to the internal resin portions in shock resistance. The shock resistance should be evaluated based on test values obtained by Izod impact test or Charpy impact test. As used here, the resin exhibiting high heat conductivity includes those containing an insulating material such as a ceramic filler that is higher in heat conductivity than the resin. For example, the internal resin portion may be an epoxy resin containing the ceramic filler, and the external resin portion may be an unsaturated polyester or polyamide. The epoxy resin containing the ceramic filler is excellent in its heat conductivity, but poor in shock resistance due to its being relatively rigid. Additionally, it is heavy because of the contained ceramic filler, and is expensive as compared to unsaturated polyester and polyamide. Accordingly, by structuring the internal resin portion which is to be brought into contact with the coil with ceramic filler containing epoxy resin, and by structuring the external resin portion with unsaturated polyester or polyamide, it becomes possible to obtain the reactor-use component being excellent in shock resistance while securing a great heat dissipation performance. Further, as compared to a case where both the internal resin portion and the external resin portion are structured with the ceramic filler containing epoxy resin, total weight of the reactor-use component can be reduced, and costs thereof can also be reduced. The material of the ceramic filler may be at least the one selected from silicon nitride, alumina, aluminum nitride, boron nitride, and silicon carbide.

### <Reactor-Use Component Manufacturing Method>

While detailed description of the manufacturing method of the reactor-use component will be given in the following Embodiments, the coil molded product can be manufactured through a method including: a step of disposing a coil in a mold; a step of inserting an inner mold so as to conform with the inner circumference of the coil; a step of injecting resin into the mold and curing the same, to obtain a molded product having the shape of the coil retained by the resin; and a step of taking out the molded product from the mold. If necessary, before the step of injecting the resin into the mold, a step of retaining the coil in a compressed state to be shorter than its free length in the mold can be carried out. In order to retain the coil in a compressed state in the mold, the coil may be compressed by being partially pushed with rod-like elements that can advance and recede in the mold.

On the other hand, the core integrated type coil molded product can be manufactured through a method including: a step of disposing in a mold a coil having internal core portions inserted therein; a step of injecting resin into the mold and curing the same, to obtain a molded product integrated with the internal core portions while having the shape of the coil retained; and a step of taking out the molded product from the mold. If necessary, before the step of injecting the resin into the mold, a step of retaining the coil in a compressed state to be shorter than its free length in the mold can be carried out. How to specifically carry out the compression of the coil is the same as in the coil molded product manufacturing method.

In a case where the internal core portions are each structured as a stacked structure made up of core pieces and gap members, and where the core pieces and the gap members are not joined to each other before the step of injecting the internal resin portion into the mold, it is preferable to hold the stacked structure by the rod-like elements that can advance and recede in the mold, so as to prevent the core pieces and the gap members from being displaced from each other in the mold. For example, the stacked structure may be clamped by the rod-like elements at a plurality of portions in the side faces of the stacked structure.

Further, as described above, in a case where a multi-layer structure made up of; the internal resin portion covering the coil; and the external resin portion covering the exterior of the internal resin portion is to be obtained, first, molding of the internal resin portion is carried out so as to retain the shape of the coil. Thereafter, the external resin portion should be molded so as to cover the internal resin portion and the exposed core portions.

### [Reactor]

### <Core>

For the reactor, the core structured in an annular shape is used. The core includes the internal core portions inserted into the coil (coil elements), and the exposed core portions that are joined to the ends of the internal core portions and that are exposed outside the coil (coil elements).

### <Internal Core Portions>

Of the core portions, as to the internal core portions, in a case where the coil molded product is used, the internal core portions are fitted into the hollow bores of the coil molded product; in a case where the core integrated type coil molded product is to be obtained, the internal core portions are integrated with the coil by the internal resin portion. Normally, the internal core portions are columnar elements inserted into the coil, and they may each be a circular cylindrical shape, a rectangular cylindrical shape, or the like. Because the internal core portions have each of a relatively simple shape and of a size adapted to be inserted into the coil, they are easily positioned in the mold at the step of molding the internal resin portions, and they do not interfere in the mold with the rod-like elements for compressing the coil.

The internal core portions may be structured with a plurality of core pieces made of a magnetic material having nonmagnetic gap members alternately interposed therebetween. Alternatively, they may be structured with no gap members and solely with the core pieces whose magnetic permeability is adjusted. The core pieces may be a laminated structure of electromagnetic steel sheets, or may be a powder magnetic core. The gap members are intended to adjust inductance of the reactor, and it may be made of alumina or the like.

Preferably, the end faces of the internal core portions are exposed outside the internal resin portion so as to be joined to the exposed core portions. Though the end faces of the internal core portions may be exposed so as to be flush with the end face of the internal resin portion, when they are projected relative to the end face of the internal resin portion, it becomes further easier to adjust the inductance of the reactor. Joining of the internal core portions and the exposed core portions is normally realized by use of an adhesive. When the end faces of the internal core portions are recessed relative to the end face of the internal resin portion, an adhesive layer at least as thick as depth of the recess is required. This makes it difficult to reduce the thickness of the adhesive layer that influences the inductance of the reactor. In contrast thereto, when the end faces of the internal core portions are projected relative to the end face of the internal resin portion, the thickness of the adhesive layer can arbitrarily be set, and hence the inductance can easily be adjusted. Further, this also facilitates application of the adhesive in a manner limiting the target to the end faces of the internal core portions. A slight amount of the projection will suffice so long as the internal core portions are surely projected, even taking into consideration of tolerances of the internal core portions and the internal resin portion. For example, it may be about some μm. Conversely, an excessive amount of projection disadvantageously increases the size of the reactor and, therefore, a smaller projection amount is preferable.

### <Exposed Core Portions>

The exposed core portions are joined to the end faces of the internal core portions as described above. The exposed core portions may also be structured of a material similar to the core pieces of the internal core portions. Typical modes of the exposed core portions include rectangular blocks, U-shaped blocks, trapezoidal blocks and the like. In a case where a coil in which a pair of coil elements is paralleled is used, the exposed core portions may be joined so as to connect between the end faces of the paired internal core portions respectively inserted into the coil elements. This joining forms an annular core that passes through inside the paired coil elements.

In particular, in a case where the core is structured with a laminated structure of electromagnetic steel sheets, which exhibits an excellent mechanical strength, an assembled product can be obtained by: inserting the internal core portions into the hollow bores of the coil molded product, and joining the exposed core portions to either end of the internal core portions; or by combining the core integrated type coil molded product and the exposed core portions. In this state, the assembled product can fully function as a reactor. On the other hand, in a case where the core is to be structured with a powder magnetic core, while such an assembled product can be obtained in the same manner, it is preferable to cover the assembled product by the external resin portion whose description will follow, to reinforce the core.

### <External Resin Portion>

The external resin portion covers the circumference of the assembled product, so as to mechanically and electrically protect the constituents of the assembled product. In addition thereto, the external resin portion also functions: to absorb vibration caused by excitation of the reactor; and to mechanically and electrically protect the coil portion exposed outside the internal resin portion, if any. Further, in a case where a case is used, the external resin portion also functions: to further enhance the insulation between the coil and the case; to retain the constituents accommodated in the case, such as the assembled product in the case; and to transfer heat of the assembled product to the case.

For the external resin portion, what can suitably used is an insulating material that does not soften when the maximum temperature of the core or the coil is reached. Examples thereof may include unsaturated polyester, epoxy resin, urethane resin and the like. A porous material that is excellent in absorbing the noise attributed to the vibration of the reactor may also be employed for the external resin portion. Specific examples may include a foamed plastic such as foamed polystyrene, foamed polyethylene, foamed polypropylene, foamed polyurethane and the like, or a foamed rubber such as foamed chloroprene rubber, foamed ethylene propylene rubber, foamed silicone rubber and the like.

In particular, in a case where epoxy resin (ceramic filler containing epoxy resin) is used as the resin for the internal resin portion, unsaturated polyester may preferably be employed for the external resin portion. While epoxy resin (ceramic filler containing epoxy resin) exhibits high hardness, its shock resistance is relatively poor. Accordingly, the internal resin portion can be protected by being covered by the external resin portion made of unsaturated polyester resin.

### <Terminal Block>

The coil is supplied with power from an external device. Normally, current leads are led out from the external device, and a terminal provided at a tip of each of the current leads is connected to the terminal block of the reactor. The terminal block is provided with terminal fittings to be connected to the ends of the wire structuring the coil elements. Normally, the terminals of the current leads are connected to the terminal fittings by bolts. The terminal block can be structured by integrating the terminal fittings by molding of the internal resin portion or the external resin portion. In this manner, use of the internal resin portion or the external resin portion to obtain the terminal block eliminates the necessity of preparing the terminal block by a separate molding step of integrating the terminal fittings, and the necessity of mounting the terminal block to the assembled product made up of the coil and the core. The terminal fittings each have a weld face to be fixed to the corresponding end of the wire structuring the coil, a connection face disposed at a position to be the terminal block, and a buried portion to be buried in the internal resin portion or the external resin portion. In particular, having the top faces of the exposed core portions lowered relative to the turn-formed face of the top of the coil to create a height difference, and disposing the connection faces of the terminal fittings and nuts at the created height difference portion, to thereby form the terminal block, the terminal block will not project higher than the turn-formed face of the coil. More specifically, the terminal fittings, except for the connection faces and the portions to be connected to the wire ends, are integrated by molding of the internal resin portion, and simultaneously, nut accommodating holes for accommodating the nuts are formed by the molding. Then, the nuts are fitted into the nut accommodating holes, and thereafter the terminal fittings are bent such that the connection faces overhang the top of the nuts. In this manner, the nuts can be prevented from coming off from the nut accommodating holes. Further, provision of the buried portion in each of the terminal fittings that connects between the weld face and the connection face functions to disperse, to the internal (external) resin portion via the connection face, stress put on an interface between the weld face and the wire end, as being incurred by action of connecting the terminal of each current lead to the corresponding connection face. Thus, an excessive stress put on the welding portion between the weld face and the wire end can be alleviated.

### <Heatsink>

It is further preferable to integrate a heatsink that is excellent in heat conductivity in the internal resin portion or the external resin portion. Generally, the reactor is mounted on a cooling base or the like through which a coolant flows. Therefore, integration of the heatsink with the face that is included in the internal resin portion of the reactor-use component and that faces the cooling base being the reactor fixation target (i.e., install face), or the face that is included in the external resin portion of the reactor and that faces the cooling base (i.e., install face) achieves efficient heat dissipation via the heatsink. Further, the integrated heatsink with the coil molded product or with the core integrated type coil molded product provides excellent assembling workability at a later process of combining with the exposed core portions to obtain the reactor. In particular, preferably, the heatsink is integrated such that one face of the heatsink is brought into surface contact with the coil having none of the resin of the internal resin portion or that of the external resin portion interposed at this contact interface, and that the other face of the heatsink is entirely exposed outside the internal resin portion or the external resin portion. Thus, the heat of the coil can quickly be transferred to the outside of the reactor via the heatsink.

The heatsink is preferably made of a material whose heat conductivity a (W/m·K) is greater than 3 W/m·K, more preferably equal to or greater than 20 W/m·K, and still more preferably equal to or greater than 30 W/m·K. Further, because the heatsink is disposed in contact with or in close proximity to the coil, the heatsink is preferably made of a nonmagnetic material in its entirety, in consideration of the magnetic characteristic. A nonmagnetic inorganic material suitably satisfies such parameters. There are a conductive nonmagnetic inorganic material and an insulating nonmagnetic inorganic material. As to the heatsink, at least the material structuring the face in contact with the coil should desirably electrically be insulated from the coil. Hence, it is preferably made of an insulating material. Accordingly, the heatsink may be made of an insulating inorganic material in its entirety, or may be in a layered structure, which is a plate-like substrate made of a conductive inorganic material whose surface is covered by a layer made of an insulating inorganic material. It is to be noted that, “insulation” refers to insulating performance enough to secure electrical insulation against the coil.

Ceramic can suitably be employed as the insulating inorganic material noted above. Specifically, it may be at least the one selected from silicon nitride (Si₃N₄): approximately 20 to 150 W/m·K, alumina (Al₂O₃): approximately 20 to 30 W/m·K, aluminum nitride (AlN): approximately 200 to 250 W/m·K, boron nitride (BN): approximately 50 to 65 W/m·K, and silicon carbide (SiC): approximately 50 to 130 W/m·K (the numerical values represent the heat conductivity). That is, the heatsink may be made of one material, or may be an integrated combination of plate pieces each made of different materials thereby exhibiting varied heat characteristic depending on its specific portions. Of the ceramic noted above, silicon nitride is preferable because of its high heat conductivity, and its being superior to alumina, aluminum nitride, and silicon carbide in bending strength.

### <Case>

The case accommodates the assembled product described above, and dissipates the heat from the body via the case. However, as to the reactor of the present invention, the assembled product can be used as a reactor as it is without being accommodated in the case, or may be used as being accommodated in the case. Dispensing with the case, the reactor can be miniaturized. On the other hand, use of the case realizes mechanical protection of the assembled product with ease. Normally, space between the assembled product and the case is filled with the external resin portion described above.

Normally, a container having front, rear, right, and left side faces and a bottom face and whose top is open is used as the case. Here, the following mode is preferable: form a step at each of the opposite ends of the bottom face; use top faces of the steps as support faces of the core (exposed core portion); and form a mid-bottom face lower than the support faces between the steps, with a clearance formed between the mid-bottom face and the reactor-use component. Use of the case in this mode makes it possible to bring the core in direct contact onto the support face and to retain the same. Therefore, the heat can efficiently be dissipated from the core via the case. Further, by setting a height difference between the support face and the mid-bottom face of the case to be greater than an interval between the surface of the core in contact with the support face and the install face of the reactor-use component, it becomes possible to form a clearance between the mid-bottom face and the install face of the case to be filled with the external resin portion. The clearance filled with the external resin portion secures insulation between the mid-bottom face of the case and the coil.

It is preferable that the case is made of a material exhibiting high heat dissipation performance. Specifically, a material being excellent in heat conductivity, in particular, a metal material can suitably be employed. Among others, aluminum or aluminum alloy is suitable.

### Embodiment 1

### Embodiment 1-1

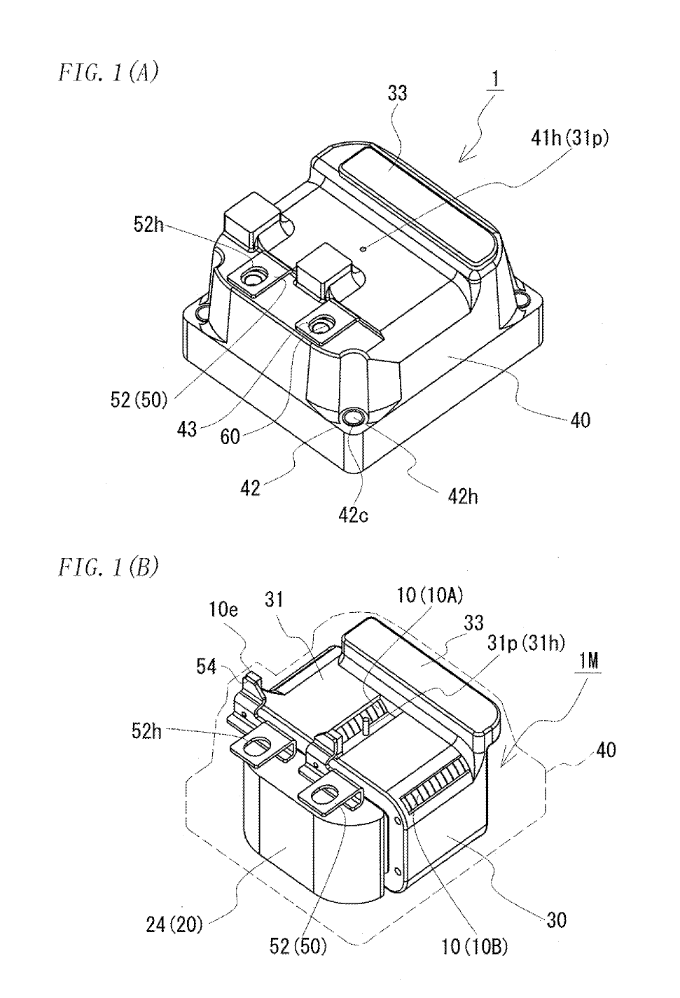

A reactor according to Embodiment 1-1 of the present invention will be described with reference to FIGS. 1 to 5.

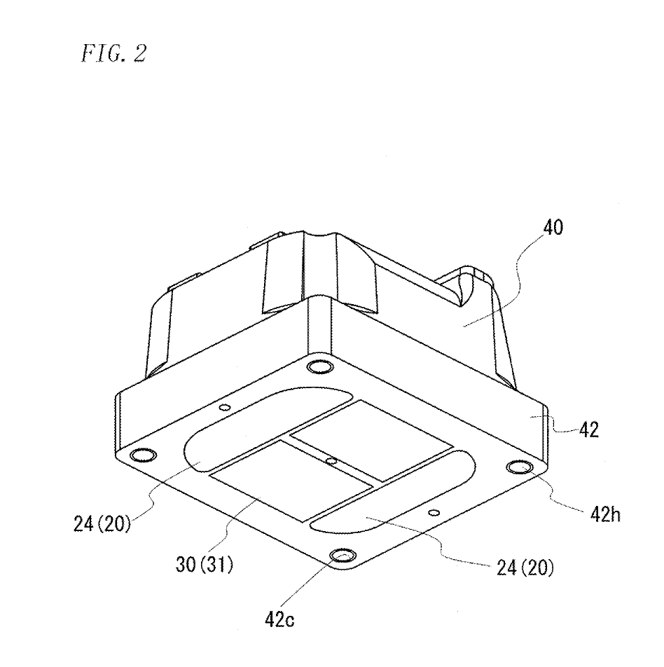

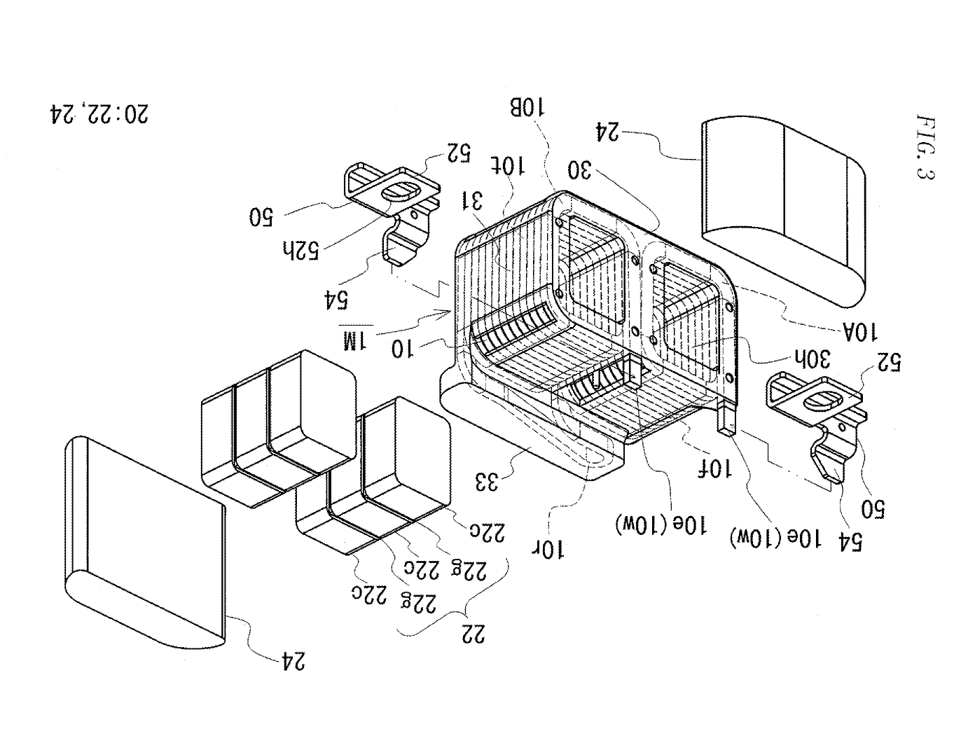

A reactor 1 is structured with an assembled product made up of a coil molded product 1M in which a coil 10 is subjected to molding of an internal resin portion 30 and an annular core 20, wherein the assembled product covered by an external resin portion 40 (FIGS. 1 and 2). The core 20 includes internal core portions 22 (FIG. 3) fitted inside the coil 10, and exposed core portions 24 that connect between end faces of the internal core portions 22 and that are exposed outside the coil 10. Further, terminal fittings 50 are integrated by molding of the external resin portion 40, and nut accommodating holes 43 are formed by the molding as well. Nuts 60 fitted into the nut accommodating holes 43 and the terminal fittings 50 structure a terminal block.

The reactor 1 is used as a constituent of a DC-DC converter for hybrid vehicles, for example. In such a case, a flat bottom face of the reactor 1 is employed as an install face (i.e., the face where the internal resin portion 30 and the exposed core portions 24 shown in FIG. 2 are exposed), and used as being directly installed on a not-shown cooling base (fixation target).

### [Coil Molded Product]

As shown in FIG. 3, the coil molded product 1M structuring the reactor 1 includes a pair of coil elements 10A and 10B, and the internal resin portion 30 covering outer circumference of the coil elements 10A and 10B.

The coil 10 includes the pair of coil elements 10A and 10B formed by a spirally wound wire 10w. The coil elements 10A and 10B are the same in the number of turns, each being a substantially rectangular coil as seen axially, and are paralleled to each other sideways such that their respective coil axes are in parallel to each other. The coils 10A and 10B are structured with a single wire with no joined portion. Specifically, at one end of the coil 10, one end 10e and the other end 10e of the wire 10w are led out upward. At the other end of the coil 10, the coil elements 10A and 10B are coupled to each other via a couple portion 10r, which is a portion of the wire 10w being bent in a U-shape. Thus, the coil elements 10A and 10B are the same in winding direction. Further, in the present embodiment, the couple portion 10r is projecting outward and higher than a turn-formed face 10f at the top of the coil elements 10A and 10B. Then, the ends 10e of the coil elements 10A and 10B are led out upward above a turn portion 10t, and are connected to terminal fittings 50 for supplying power to the coil elements 10A and 10B.

What is used as the wire 10w structuring the coil elements 10A and 10B is a coated rectangular wire, which is a copper-made rectangular wire coated by enamel. The coated rectangular wire is wound edgewise, to form the hollow prism-shaped coil elements 10A and 10B.

At an outer circumference of the coil 10 having the structure described above, the internal resin portion 30 that retains the coil 10 in a compressed state is formed. The internal resin portion 30 includes a turn covering portion 31 that covers the turn portion 10t of the coil elements 10A and 10B so as to substantially conform to an outer shape of the coil elements 10A and 10B, and a couple portion covering portion 33 that covers an outer circumference of the couple portion 10r. The turn covering portion 31 and the couple portion covering portion 33 are integrally molded, and the turn covering portion 31 covers the coil 10 by a substantially uniform thickness. As a result, hollow bores 30h are formed inside the turn covering portion 31. It is to be noted that, the corners of the coil elements 10A and 10B and the ends 10e of the wire are exposed outside the internal resin portion 30. Further, the turn covering portion 31 chiefly functions to secure the insulation between the coil elements 10A and 10B and internal core portions 22, whose description will be given later, and to position the internal core portions 22 relative to the coil elements 10A and 10B. On the other hand, the couple portion covering portion 33 functions to mechanically protect the couple portion 10r in the step of forming the external resin portion 40 (FIGS. 1 and 2) at the outer circumference of the reactor 1.

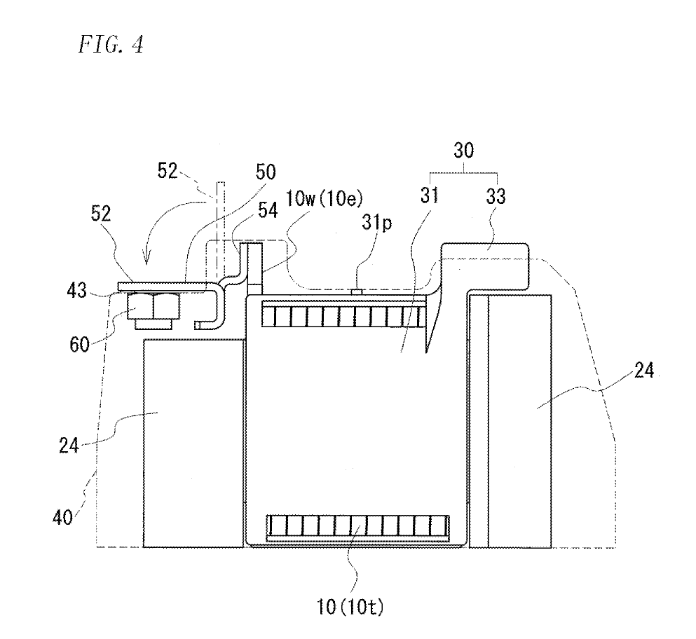

Further, between the coil elements 10A and 10B in the internal resin portion 30, a sensor-use hole 31h for storing a not-shown temperature sensor (e.g., a thermistor) is formed (FIG. 1 (B)). In the present embodiment, a sensor storing pipe 31p is partially encapsulated in the internal resin portion 30 by insert molding, to serve as the sensor-use hole 31h. As shown in FIGS. 1 (B) and 4, the sensor storing pipe 31p slightly projects higher than the turn covering portion 31 that covers the turn portion 10t of the coil among those portions constituting the internal resin portion 30. The material of the sensor storing pipe 31p may be metal such as stainless steel, or resin such as silicone, epoxy and the like. It is to be noted that the sensor storing pipe 31p itself is not essential. What is required is just a hole capable of storing a prescribed sensor being left after the step of molding the external resin portion 40, the description of which step will be given later. For example, such a sensor-use hole may be formed by molding directly at the external resin portion 40 (and additionally at the internal resin portion 30, if necessary).

The internal resin portion 30 described above is made of a material that exhibits excellent heat-resistance enough to withstand heat generated by the reactor 1, heat conductivity for dissipating the generated heat to the outside of the reactor 1, and insulation. Here, epoxy resin is employed for the internal resin portion 30.

### [Core]

When the coil 10 is excited, the core 20 forms an annular magnetic path. In the core 20, the internal core portions 22 are each a member in a shape of substantial rectangular parallelepiped. As shown in FIG. 3, each internal core portion is made up of core pieces 22c each being a powder magnetic core, and gap members 22g each being an alumina plate, the core piece 22c and the gap member 22g being alternately disposed and bonded by an adhesive. On the other hand, each exposed core portion 24 is a powder magnetic core, being a block element whose corners at a face away from the coil molded product 1M are formed as arc-shaped faces. The exposed core portions 24 are disposed so as to connect between the opposite ends of a pair of paralleled internal core portions 22, and joined to the internal core portions 22 by an adhesive. Such a disposition of the internal core portions 22 and the exposed core portions 24 forms the core 20 being a closed loop (i.e., annular).

The exposed core portions 24 in the core 20 as being assembled into the annular shape project lower than the faces of the internal core portions 22 corresponding to the install face (i.e., the bottom faces opposite to the projection direction of the ends 10e), so as to be substantially flush with the bottom face of the coil molded product 1M corresponding to the install face. Thanks to such a structure, fixation of the reactor 1 to a cooling base brings not only the internal resin portion 30 but also the exposed core portions 24 into contact with the cooling base. Hence, the heat generated by the reactor 1 in operation can efficiently be dissipated.

Further, as shown in FIG. 4, one of the exposed core portions 24 (the one on the left side in FIG. 4) that is disposed beside the ends 10e of the wire is smaller in height than the top face of the turn covering portion 31 of the coil 10; whereas the other one of the exposed core portions 24 (the one on the right side in FIG. 4) that is disposed under the couple portion covering portion 33 is the same in height as the top face of the turn covering portion 31. Meanwhile, the one exposed core portion 24 is greater in thickness (i.e., the dimension in the coil axis direction) than the other exposed core portion 24. That is, the exposed core portions 24 secure substantially equivalent volumes, thereby being substantially equivalent in magnetic characteristic to each other. Further, arrangement of the couple portion 10r positioned higher than the turn-formed face 10f (FIG. 3) makes it possible to dispose the thinner one of the exposed core portions 24 under the couple portion covering portion 33. Thus, reduction in the projected area of the reactor can be achieved.

### [External Resin Portion]

The external resin portion 40 is formed such that the bottom face of the coil molded product 1M and the bottom faces of the exposed core portions 24 are exposed, and that the most of the top face and the entire outer side faces of the assembled product made up of the coil molded product 1M and the core 20 are covered. Exposure of the bottom face of the coil molded product 1M and the bottom faces of the exposed core portions 24 outside the external resin portion 40 allows the heat generated by the reactor 1 to efficiently be dissipated toward the cooling base. Further, the external resin portion 40 covering the top face and the outer side faces of the assembled product in the manner described above achieves mechanical protection of the assembled product.

More specifically, as shown in FIGS. 1 and 2, the external resin portion 40 is formed such that the bottom faces of the exposed core portions 24 and the coil molded product 1M (turn covering portion 31) are exposed on the side corresponding to the install face of the reactor 1, and that the top face of the couple portion covering portion 33 is exposed on the top side of the reactor 1. The terminal fittings 50 each include a connection face 52 for connecting to any external device and a weld face 54 to be welded to the end 10e of the wire. Here, the terminal fittings 50 are mostly buried in the external resin portion 40, and only the connection faces 52 are exposed outside the external resin portion 40 (FIG. 4). The connection faces 52 are both disposed on the one exposed core portion 24, the space between the top face of the exposed core portion 24 and the connection faces 52 being filled with the external resin portion 40, to structure the terminal block. In the terminal block, a nut accommodating hole 43 is formed under each connection face 52 by molding. In the present embodiment, the nut accommodating hole 43 is formed to have a hexagonal cross-section. The nut accommodating hole 43 accommodates a hexagonal nut 60 in a locked state. The connection faces 52 are each arranged to overhang the opening of the nut accommodating hole 43. Each connection face 52 is provided with an insertion hole 52h whose inner diameter is smaller than the diagonal dimension of the diagonal nut 60. Thus, the connection faces 52 prevent the nut 60 from coming off from the nut accommodating holes 43. When the reactor is to be used, a terminal provided at the tip of a not-shown current lead is overlaid on each connection face 52, and a bolt is penetrated through the terminal and the connection face 52 to screw with the nut 60. Thus, the coil 10 is supplied with power from the external device (not shown) connected to a base end of the current lead.

The external resin portion 40 includes flange portions 42 that project outer than the contour of the assembled product made up of the coil molded product 1M and the core 20 when the reactor is seen two-dimensionally (FIGS. 1 (A) and 2). At the flange portion 42, through holes 42h for bolts (not shown) for fixing the reactor 1 to the cooling base are formed. In the present example, metal collars 42c are placed by insert molding of the external resin portion 40, an interior of each collar 42c being formed as the through hole 42h. The metal collars 42c may be made of brass, steel, stainless steel or the like.

The external resin portion 40 further includes a protective portion at its top face, which covers joined portions between the coil ends 10e and the terminal fittings 50 (FIGS. 1 and 4). The protective portion is molded into a substantially rectangular block shape. Additionally, the external resin portion 40 has its top face molded so as to be flush with a tip of the sensor storing pipe 31p projecting from the internal resin portion 30.

As shown in FIG. 4, the external resin portion 40 has its side faces formed as sloped faces that widen from the top toward the bottom of the reactor 1. Provision of such sloped faces facilitates removal of the molded reactor from the mold in a case where the external resin portion is molded through a step of molding the same by molding the assembled product made up of the coil molded product and the core in an upside-down state, the description of which step will be given later.

The external resin portion 40 having been described in the foregoing can be structured with, for example, epoxy resin, urethane resin, unsaturated polyester resin or the like, each of which is a thermosetting resin. In particular, unsaturated polyester resin is preferable because it exhibits excellent heat conductivity, is less prone to crack and is cost-effective.

### <Reactor Manufacturing Method>

The reactor 1 described in the foregoing is manufactured through the following (1) to (3) general steps.

(1) A first molding step of molding the internal resin portion over the coil to obtain the coil molded product.

(2) An assembling step of assembling the coil molded product and the core into the assembled product.

(3) A second molding step of molding the external resin portion over the assembled product to complete the reactor.

### (1) First Molding Step

First, by winding one wire, the coil 10 in which the coil elements 10A and 10B are paired by the couple portion 10r is formed. Subsequently, prepare a mold for molding the internal resin portion 30 over the outer circumference of the produced coil 10, and place the coil 10 in the mold. Here, the portions corresponding to the corners of the coil elements 10A and 10B are supported by convex portions (not shown) at an inner face of the mold, such that a certain gap is formed between the inner face of the mold, except for the convex portions, and the coil 10.

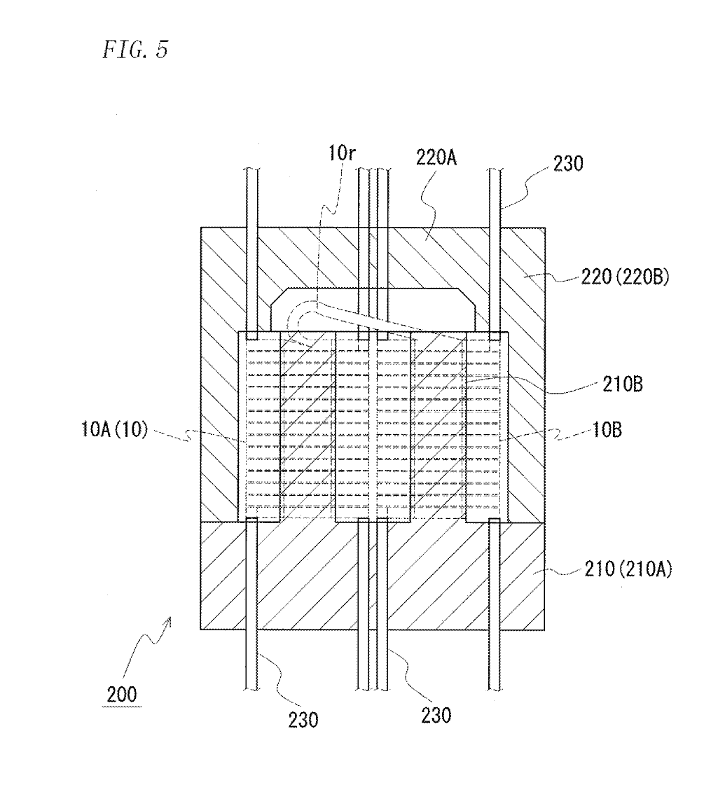

As shown in FIG. 5, a mold 200 used in molding is structured with a pair of first mold 210 and a second mold 220 that opens and closes. The first mold 210 includes an end plate 210A positioned at one end (leading end and terminating end) of the coil 10 and an inner mold 210B that is inserted into the inner circumference of the coil 10. On the other hand, the second mold 220 includes an end plate 220A positioned at the other end of the coil (where the couple portion 10r is), and a sidewall 220B covering the circumference of the coil 10.

Further, the first and second molds 210 and 220 are provided with a plurality of rod-like elements 230 that can advance into and recede from the inside of the mold 200 by means of a not-shown drive mechanism. Here, a total of eight rod-like elements 230 are used, to push the substantial corner portions of the coil elements 10A and 10B, to thereby compress the coil 10. It is to be noted that, because it is difficult for the couple portion 10r to be pushed by the rod-like elements 230, the portion below the couple portion 10r as seen in FIG. 5 is pushed by the rod-like elements 230. In order to minimize the portions where the coil 10 is uncoated by the internal resin, the rod-like elements 230 are formed as thin as possible, while securing the strength and heat-resistance enough to compress the coil 10. At the stage where the coil 10 is placed in the mold 200, the coil 10 is still uncompressed, and there exists a clearance between adjacent turns.

Next, the mold 200 is closed, to insert the inner mold 210B into the inside of the coil 10. Here, an interval between the inner mold 210B and the coil 10 should be substantially constant over the entire circumference of the inner mold 210B.

Subsequently, the rod-like elements 230 advance into the mold 200 to compress the coil 10. This compression brings the adjacent turns of the coil 10 into contact with each other, thereby substantially eliminating the clearance between the adjacent turns.

Thereafter, an epoxy resin is injected from a not-shown resin injection port into the mold 200. When the injected resin has cured to a certain extent to be capable of retaining the coil 10 in a compressed state, the rod-like elements 230 may recede from the mold 200.

When the resin has cured and the coil molded product that retains the coil 10 in a compressed state is molded, the mold 200 is opened and the molded product is taken out from the mold.

The obtained coil molded product 1M (FIG. 3) has its positions having been pushed by the rod-like elements 230 uncoated by the internal resin portion, and hence the coil molded product 1M is molded into a shape with a plurality of small pores. The small pores may be filled with an appropriate insulating material, or may be left as they are.

### (2) Assembling Step

First, at each end of the wire of the produced coil molded product 1M, the terminal fitting 50 is welded. At this stage of welding, as represented by a broken line in FIG. 4, the connection face 52 of the terminal fitting is arranged substantially in parallel to the weld face 54. After the external resin portion 40 is molded, the connection face 52 is bent approximately by 90° so as to overhang the nut 60.

Next, the internal core portions 22 are fitted into the hollow bores 30h of the coil molded product 1M. Subsequently, the end faces of the internal core portions 22 are sandwiched by the exposed core portions 24. The internal core portions 22 and the exposed core portions 24 are joined to each other to form the annular core 20. In joining the exposed core portions 24 and the internal core portions 22 to each other, an adhesive is used.

### (3) Second Molding Step

Next, prepare a mold for forming the external resin portion 40 over the outer circumference of the assembled product obtained in the assembling step. The mold includes a container-like base having an opening at the top portion, and a lid that closes the opening of the base. Inside the base, the assembled product is accommodated in an upside-down state, i.e., lying on its top face shown in FIG. 1 (B).

An internal bottom face of the base is formed so as to shape the outer shape of the external resin portion 40 shown in FIG. 1, i.e., mainly the shape of the upper portion of the reactor 1 out of its entire outer shape. Specifically, at the internal bottom face of the base, a concave portion is formed. Into this concave portion, the couple portion covering portion 33 of the coil molded product 1M can be fitted. This fitting facilitates the positioning of the assembled product inside the base. Additionally, convex portions for molding the nut accommodating holes 43 shown in FIG. 4 are also formed at the internal bottom face of the base.

At the internal bottom face of the base, a total of three resin injection gates aligned on a line are formed. Out of the three gates, an inner gate at the intermediate position opens between the paired coil elements 10A and 10B which are paralleled to each other when the assembled product is disposed in the base. The other two outer gates on either side of the inner gate open at positions such that respective corresponding ones of the exposed core portions 24 are interposed relative to the inner gate.

On the other hand, the face of the lid opposite to the base is formed as a flat face, whereby the install face of the reactor can be molded into a flat surface. With the face of the lid opposite to the base being a flat face, because the lid is free of convex and concave portions which tend to trap the air when resin is injected into the mold having the lid closed, the external resin portion 40 is less likely to suffer from defectiveness. It is to be noted that, provided that no convex and concave portions are to be formed at the install face of the reactor 1, the lid can be dispensed with, and just the injection of the resin into the base will suffice. In such a case, fluid level of the injected resin will form the install face.

When the assembled product is disposed in the mold, the lid closes the opening of the base. When the mold is closed, unsaturated polyester to be the external resin portion is injected from the resin injection gates into the mold. Because the resin is injected from the inner side and the outer side of the annular core, pressure acting upon the core from the inner side toward the outer side of the core, and pressure acting upon the core from the outer side toward the inner side of the core cancel out with each other, and hence, the mold can be filled with the resin quickly without damaging the core. This effect is particularly remarkable when the injection pressure of the resin is high.

When the molding of the external resin portion 40 has finished, the mold is opened such that the reactor 1 is taken out from the inside. Thereafter, the nuts 60 are fitted into the nut accommodating holes 43 of the taken out reactor (FIG. 4). Then, the connection faces 52 of the terminal fittings are bent approximately by 90°, such that the connection faces 52 overhang the nuts 60, to complete the reactor.

With the reactor-use component (coil molded product 1M) and the reactor of the present invention described in the foregoing, the following effects can be achieved.

Because the internal resin portion 30 retains the coil 10 so as to be incapable of expanding or compressing, the conventional disadvantage of difficulty in handling the expansion and the compression of the coil can be solved.

Because the internal resin portion 30 functions also to insulate between the coil 10 and the core 20, a sleeve-like bobbin or a frame-like bobbin used for conventional reactors can be dispensed with.

Because the sensor-use hole 31h (41h) is molded simultaneously with the molding of the internal resin portion 30 and the external resin portion 40, it is not necessary to form the sensor-use hole 31h (41h) in a later process. Therefore, the reactor 1 can be manufactured efficiently, while avoiding damage to the coil 10 and the core 20 which may otherwise be done when forming the sensor-use hole in a later process.

Because the couple portion 10r of the coil is raised higher than the turn-formed face 10f, it is not necessary for the top and bottom faces of the internal core portions 22 to be flush with the top and bottom faces of the exposed core portions 24. Therefore, at least one of the top and bottom faces of each exposed core portion 24 can project higher or lower than the top and bottom faces of each internal core portion 22. That is, while the height of the exposed core portions 24 is increased, the thickness (the length in the coil axis direction) thereof can be reduced. Thus, projected area of the reactor 1 can be reduced. In particular, by structuring the core 20 with a powder magnetic core, the core 20 in which the exposed core portions 24 and the internal core portions 22 are different from each other in height can easily be molded. Further, because the bottom faces of the exposed core portions 24 are flush with the bottom face of the coil molded product 1M and the bottom face of the external resin portion 40, the install face of the reactor 1 can be formed as a flat face and a wide contact area with the fixation target can be secured. This makes it possible to achieve efficient heat dissipation.

Because the reactor is made up of two layers of the internal resin portion 30 and the external resin portion 40, the reactor 1 which is mechanically and electrically protected can easily be formed. In particular, because the internal resin portion 30 is formed of a resin exhibiting high heat dissipation performance and the external resin portion 40 is formed of a resin exhibiting high shock resistance, a reactor exhibiting both the heat dissipation performance and the mechanical strength can be obtained. In particular, provision of the external resin portion 40 realizes the reactor 1 possessing high mechanical strength despite its core being structured with a powder magnetic core of soft magnetic powder.

Because the terminal fittings 50 are integrally formed by molding of the external resin portion 40, the terminal block can be structured simultaneously with the molding of the external resin portion 40. Therefore, any members or works for fixing a separately produced terminal block to the reactor 1 can be dispensed with.

Because not the nuts 60 themselves but the nut accommodating holes 43 are formed by molding of the external resin portion 40, there are no nuts 60 at the time of molding the external resin portion 40. Thus, the resin structuring the external resin portion 40 can be prevented from entering inside the nuts. On the other hand, because the connection faces 52 of the terminal fittings 50 are bent to overhang the openings of the nut accommodating holes after accommodating the nuts 60 in the nut accommodating holes 43, the nuts 60 can be easily prevented from coming off.

Because the through holes 42h for fixing the reactor 1 to the cooling base are formed by molding at the flange portion 42 of the external resin portion 40, the reactor 1 can be installed by simply inserting bolts into the through holes 42h to screw into the cooling base, without necessity of separately preparing any hardware for fastening the reactor other than the bolts. In particular, use of the metal collars 42c for the through holes 42h contributes to reinforcing the through holes 42h, and suppressing occurrence of cracks at the flange portion 42 which may otherwise be caused by tightening of the bolts.

### Embodiment 1-2

In Embodiment 1-1, it has been described that, in the second molding step, the assembled product is accommodated in the mold in an upside-down state when the external resin portion 40 is molded. On the other hand, the assembled product may be accommodated in the mold in an erect state. In such a case, the convex and concave portions formed at the internal bottom face of the base of the mold in Embodiment 1-1 should be formed on the lid side; and conversely, the internal bottom face of the mold should be formed as a flat face. Further, it is preferable that the base can be divided into the bottom face and the side faces such that the reactor 1 can easily be taken out from the mold. In this manner, even when the assembled product is placed in an erect state, the reactor similarly to that according to Embodiment 1-1 can easily be formed. In this case, the concave portion into which the couple portion covering portion 33 of the assembled product is fitted may be window-shaped, where the couple portion covering portion 33 is exposed outside the lid.

### Embodiment 2

### Embodiment 2-1

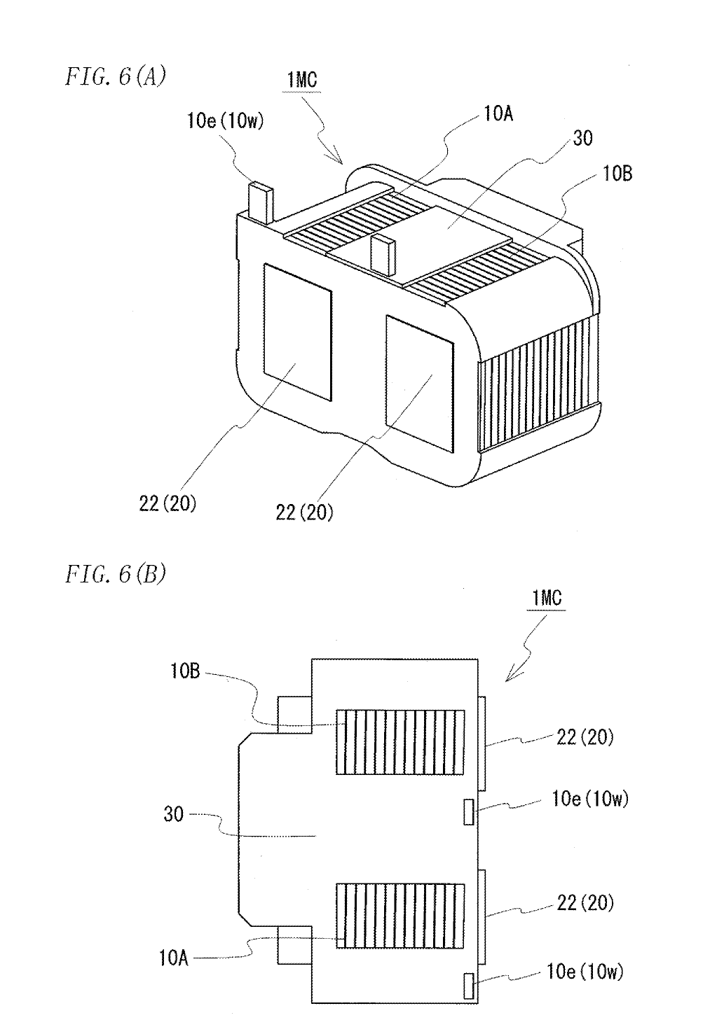

Next, with reference to FIGS. 6 to 9, a description will be given of an embodiment using a core integrated type coil molded product, which is the integrated coil and internal core portions formed by molding of the internal resin portion.

The major difference of the Embodiment 1-1 from the present embodiment lies in that the internal core portions are integrated by molding of the internal resin portion, and the rest of the structure is substantially identical to that of Embodiment 1-1. Therefore, in the following, a description will be given focusing on the difference.

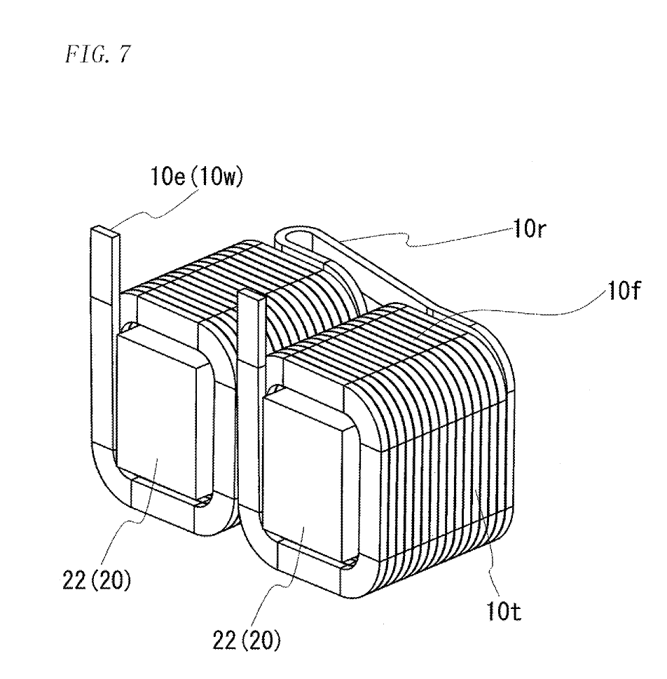

As shown in FIG. 6, this core integrated type coil molded product 1MC includes a coil 10, internal core portions 22 fitted into the coil 10, and an internal resin portion 30 that is molded so as to integrate the coil 10 and the internal core portions 22. As shown in FIG. 7, the coil 10 according to the present embodiment is similarly structured as the coil 10 according to Embodiment 1-1 except that the couple portion 10r is substantially flush with the turn-formed face 10f. In the core integrated type coil molded product 1MC, the opposite end faces of the internal core portions 22 are partially exposed outside the end face of the internal resin portion 30 (see FIG. 6 (B)). This structure facilitates the joining between the exposed core portions 24 and the internal core portions 22. In particular, restriction attributed to thickness of the adhesive layer interposed between the internal core portions 22 and the exposed core portions 24 is small, and therefore, the inductance of the reactor can be adjusted with ease. For ease of description, the projection state of the end faces of the internal core portions 22 is emphasized in FIG. 6 (B). It is to be noted that the actual projection amount is about 0.2 mm.

Further, in the present embodiment, the portions in the internal resin portion 30 that cover the coil 10 are different from those in Embodiment 1-1. Specifically, while the corners of the coil elements 10A and 10B are exposed outside the internal resin portion 30 in Embodiment 1-1, the top face and the side faces of the coil elements 10A and 10B are partially exposed in the present embodiment, and the corners of the coil elements 10A and 10B are covered by the internal resin portion 30. In this case, when the internal resin portion 30 is molded, the top face and the side faces of the coil 10 can be held in the mold, whereby the coil 10 can stably be held in the mold.

Such a core integrated type coil molded product 1MC can also be manufactured by employing the technique of Embodiment 1-1.

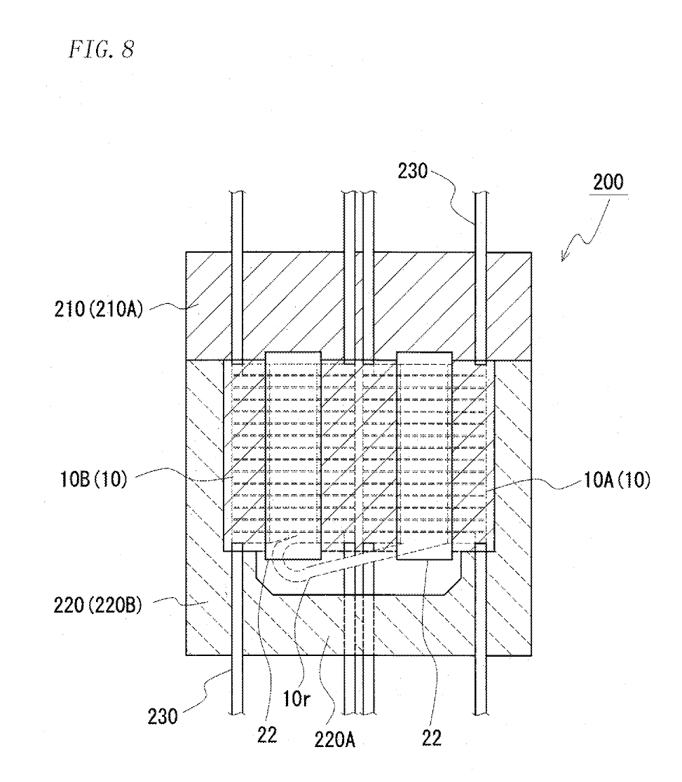

First, as shown in FIG. 7, the internal core portions 22 are fitted into the turn portions 10t of the coil elements 10A and 10B. The coil containing the core in this state is disposed in the mold 200 (FIG. 8).

As to molding of the internal resin portion, in Embodiment 1-1, the inner mold is used because the hollow bores must be formed in the internal resin portion. In contrast thereto, in the present embodiment, the internal core portions 22 have the function commensurate to the inner mold.

The mold 200 used in molding the internal resin portion is basically similar to the mold 200 used in Embodiment 1-1 except that there is no inner mold. In the present embodiment, the coil 10 and the internal core portions 22 are disposed such that the end face of the coil 10 where the couple portion 10r is positioned is directed downward, and the other end face is directed upward. When a coil axis direction is aligned with an upright direction of the mold 200, a stacking direction of the core pieces 22c and the gap members 22g being the constituents of the internal core portions 22 (see FIG. 3) becomes the upright direction. Accordingly, even when the core pieces and the gap members are not joined to each other, the core pieces and the gap members can be disposed at a prescribed position in the mold 200 with ease. In particular, having the coil 10 and the internal core portions 22 disposed in the mold 200 such that the axial direction of the coil 10 becomes the upright direction, it becomes easier to coaxially dispose the internal core portions 22 and the coil 10 as compared to a case where the coil 10 and the internal core portions 22 are disposed in the mold such that the axial direction of the coil 10 extends along the horizontal direction.

The procedure of closing the mold 200, advancing the rod-like elements 230 into the mold 200 to compress the coil 10, to thereby substantially eliminate the clearance between the adjacent turns of the coil 10 is the same as in the Embodiment 1-1.

Thereafter, from a not-shown resin injection port, an epoxy resin containing filler is injected into the mold 200. As the filler, aluminum nitride powder possessing high heat conductivity is used.

When the resin has cured and the core integrated type coil molded product 1MC that retains the shape of the coil 10 is molded, the mold 200 is opened and the molded product is taken out from the mold.

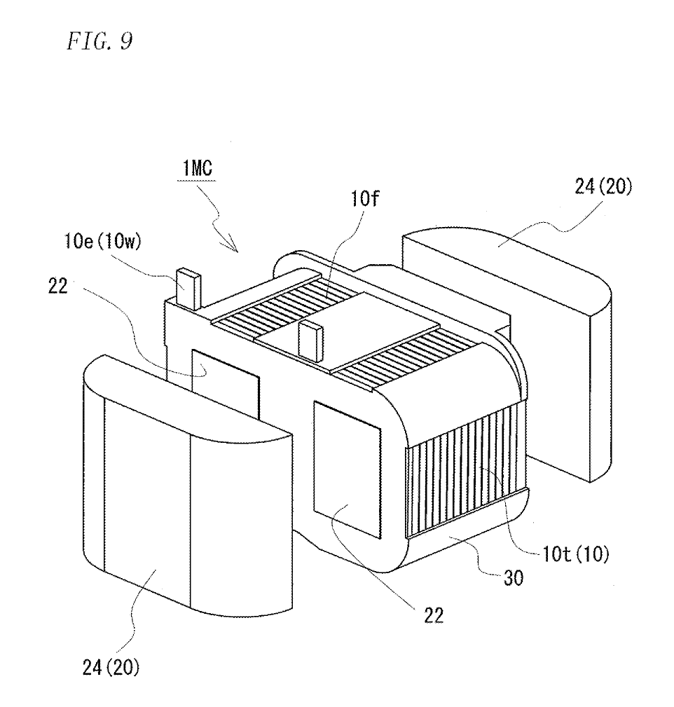

When the core integrated type coil molded product 1MC is obtained, the exposed core portions 24 are adhered to the end faces of the internal core portions 22 (FIG. 9). The following procedure of welding the terminal fittings to the wire ends to obtain the assembled product made up of the core and the coil, and molding the external resin portion over the assembled product is the same as in Embodiment 1-1.

The reactor-use component (core integrated type coil molded product 1MC) and the reactor 1 of the present embodiment achieve the following effects, in addition to those achieved by the reactor-use component and the reactor according to Embodiment 1-1.

Because the internal resin portion 30 not only retains the shape of the coil 10 so as to be incapable of expanding or compressing, but also is molded so as to integrate the internal core portions 22, the coil 10 and the internal core portions 22 can be handled as a single component. Thus, manufacturability of the reactor can be improved.

### Embodiment 2-2

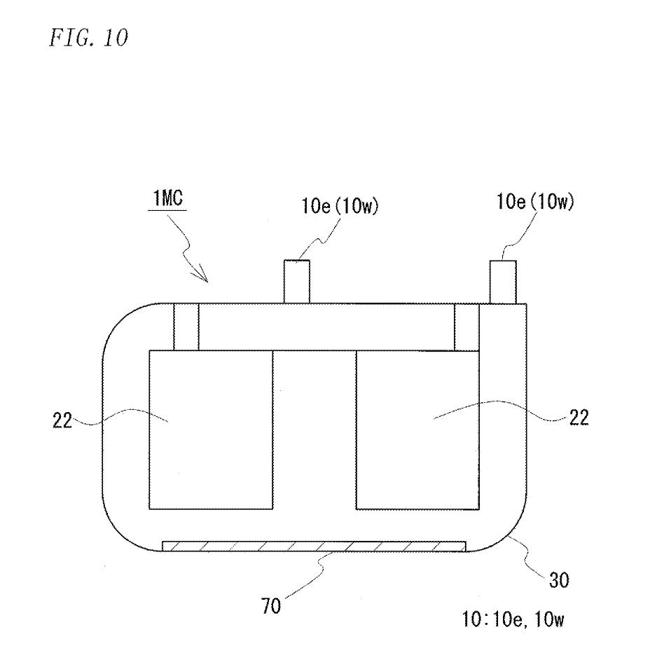

Next, with reference to FIG. 10, a description will be given of a structure in which a heatsink 70 is integrated with the bottom face (i.e., on the install face side) of the core integrated type coil molded product 1MC. The heatsink 70 is integrated with the coil 10 and the internal core portions 22 by the resin structuring the internal resin portion 30. This structure makes it possible to implement the heatsink 70 as an integrated component with the coil 10 and the internal core portions 22 without the necessity of use of any fixing member such as an adhesive, bolts or the like. As the material of the heatsink 70, alumina (Al₂O₃) is used. The space between the bottom face of the turn portion of the coil and the heatsink 70 may be filled with the resin structuring the internal resin portion 30. However, more efficient heat dissipation can be expected when the heatsink 70 is integrated with the internal resin portion 30 without having such a constituent resin interposed.

With the core integrated type coil molded product 1MC according to the present embodiment, because the heatsink 70 exhibiting an excellent heat conductivity is integrated by the internal resin portion 30, the coil 10, the internal core portions 22, and the heatsink 70 can be handled as a single member. Thus, the manufacturability of the reactor can be improved. Further, because the heatsink 70 is exposed outside the external resin portion 40 so as to face the cooling base, it becomes possible to achieve efficient heat dissipation via the heatsink 70.

### Embodiment 2-3

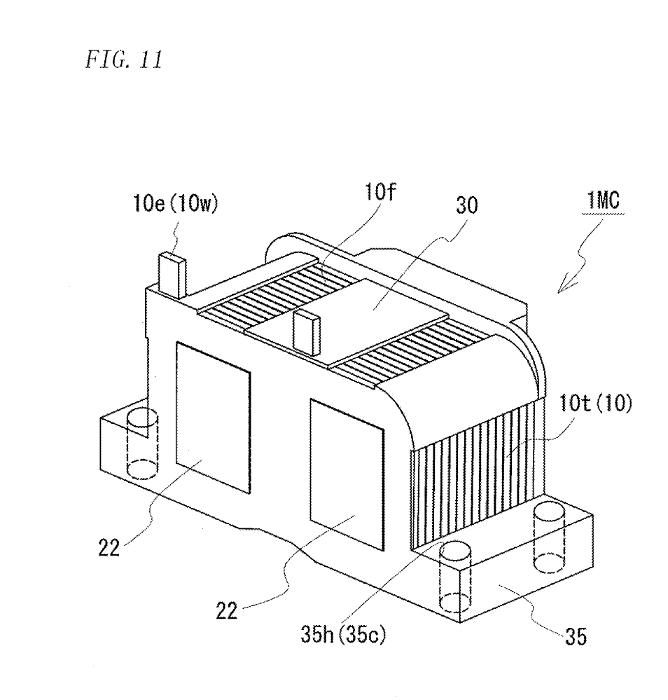

Next, with reference to FIG. 11, a description will be given of a structure in which flange portions for fixing the reactor to the cooling base is provided at a part of the internal resin portion. The core integrated type coil molded product 1MC of the present embodiment is similarly structured as the core integrated type coil molded product 1MC according to Embodiment 1-1 except that flange portions 35 are provided. In the following, a description will be given focusing on the difference from Embodiment 1-1.

The core integrated type coil molded product 1MC according to the present embodiment includes flange portions 35 that project toward either side of the core integrated type coil molded product 1MC at the bottom thereof. The flange portions 35 are structured as a part of the internal resin portion 30. The flange portions 35 are simultaneously formed when the internal resin portion 30 is molded.

At each of the flange portions 35, a pair of through holes 35h for fixing the reactor to the cooling base by use of bolts is formed. In the present embodiment, metal collars 35c are placed by insert molding of the internal resin portion 30, the interior of each metal collar 35c being formed as the through hole 35h. The metal collar 35c also may be made of brass, steel, stainless steel or the like. The size of the flange portions 35 and the number of the through holes 35h are not particularly limited.

The procedure following the molding of the core integrated type coil molded product 1MC of the present embodiment, i.e., joining the exposed core portions to the end faces of the internal core portions 22 to obtain the assembled product, and covering the assembled product by the external resin portion is the same as Embodiment 1-1.

This structure makes it possible to fix the reactor to the cooling base using the flange portions 35 of the internal resin portion 30, without the necessity of forming the flange portions at the external resin portion 40.

### Embodiment 3

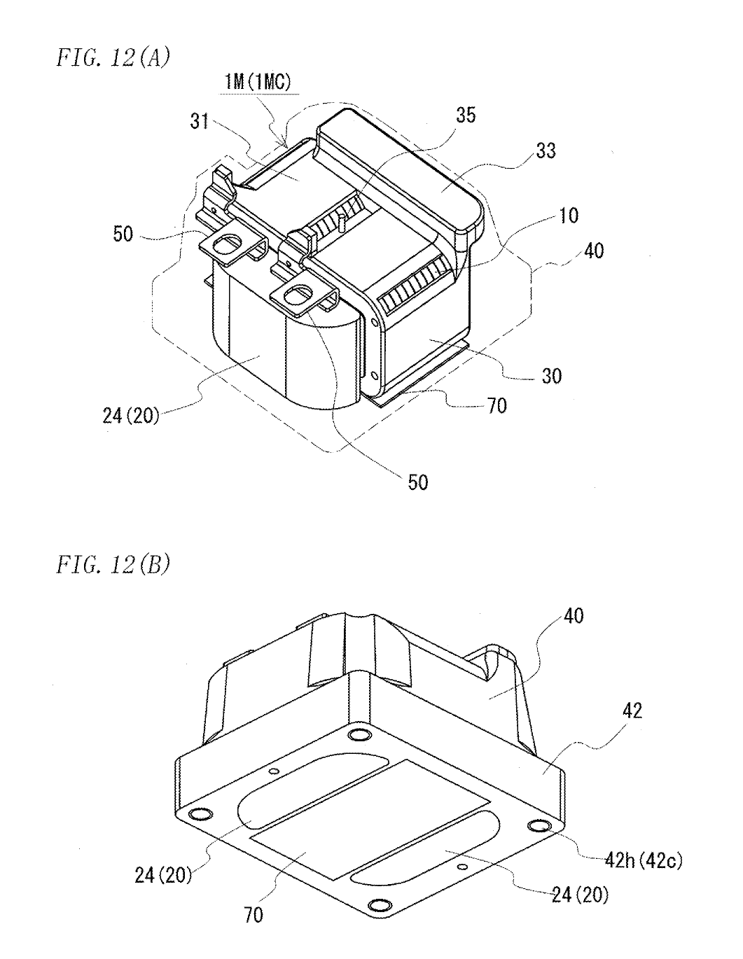

Next, with reference to FIG. 12, a description will be given of a structure in which a heatsink is integrated by an external resin portion.

In Embodiment 2-2, the heatsink is integrated by the internal resin portion. The coil molded product according to the present embodiment is similar to the coil molded product according to Embodiment 1-1, except that the heatsink is integrated with the coil molded product by the external resin portion.

In the present embodiment, what is used is a rectangular heatsink 70 whose area is substantially equivalent to that defined by the contour of the coil molded product 1M (1MC) when seen two-dimensionally. As the heatsink 70, alumina can suitably be used, for example. In the second molding step in Embodiment 1-1, when molding the external resin portion 40, the heatsink 70 is disposed on the install face of the assembled product. Here, the bottom faces of the exposed core portions 24 and the heatsink 70 should be flush with each other. Then, the external resin portion 40 is molded such that the bottom faces of the exposed core portions 24 and the heatsink 70 are exposed outside the external resin portion 40 and that the bottom face of the external resin portion 40 is also flush with the heatsink 70 and the bottom faces of the exposed core portions 24.

With this structure, the heatsink 70 integrated by the external resin portion 40 implements the reactor 1 that can efficiently dissipate heat via the heatsink 70. In particular, because the coil molded product 1M (1MC) is molded by having the install face side of the coil 10 exposed outside the internal resin portion 30, the heatsink 70 substantially solely is interposed between the coil 10 and the cooling base. Therefore, efficient heat dissipation via the heatsink 70 can be expected.

### Embodiment 4

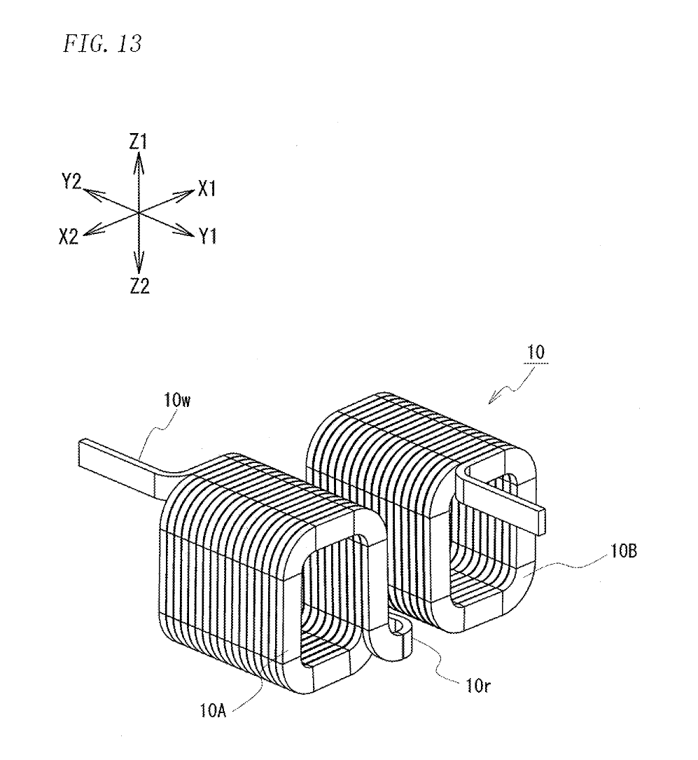

Next, with reference to FIGS. 13 to 16, a description will be given of an embodiment in which the coil has the couple portion disposed between the paired coil elements.

The present embodiment is characterized the most by the shape of the coil and the molding method thereof. In the following, a description will be given solely of the coil used in the present embodiment. The procedure that follow, i.e., molding of the internal resin portion, assembling of the core and the coil molded product, or assembling of the exposed core portions and the core integrated type coil molded product, and molding of the external resin portion can be carried out similarly as in Embodiments 1-1 and 2-1, and hence the description thereof will not be repeated.

### <Coil Structure>

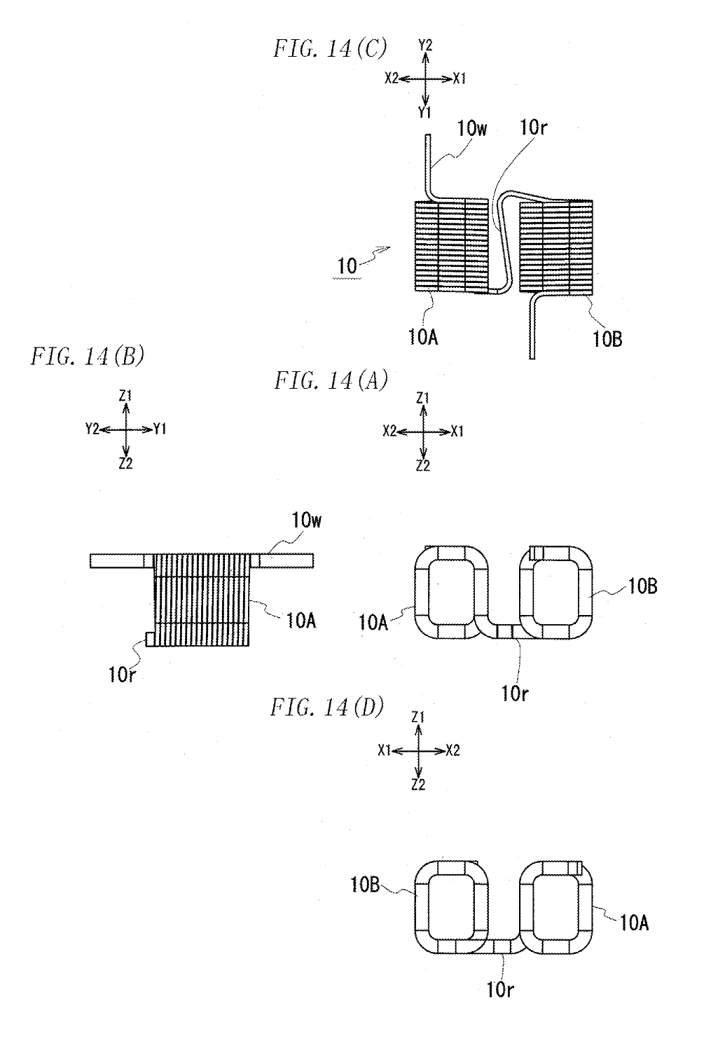

As shown in FIGS. 13 and 14, the coil used in the present embodiment includes a pair of coil elements 10A and 10B formed by a spirally wound wire and arranged in parallel to each other, and a couple portion 10r connecting the coil elements.

Before proceeding with the description of the coil, the following definition is given: a coil height direction is the direction (Z1-Z2 direction) perpendicular to both a paralleled direction of the coil elements 10A and 10B (X1-X2 direction) and a coil axis direction (Y1-Y2 direction) of the coil elements 10A and 10B perpendicular to the paralleled direction; and a direction along winding axes of the coil elements 10A and 10B and extending from the wire ends 10e toward the couple portion 10r is a spiral progressing direction of the coil elements 10A and 10B.

The spiral progressing direction of the one coil element 10A is in the Y1 direction, and its winding direction is counterclockwise. Further, the end 10e of the coil element 10A is bent flatwise in the Y2 direction being the winding axis of the wire at the top end of the coil element 10A, and led out in the Y2 direction.

The spiral progressing direction of the other coil element 10B is in the Y2 direction which is opposite to that of the one coil element 10A, and its winding direction is clockwise. The end 10e of the coil element 10B is bent flatwise in the Y1 direction being the winding axis at the top end of the coil element 10B, and led out in the Y1 direction.

The ends of the coil elements may be led out in sideways or upward relative to the coil elements 10A and 10B.

The couple portion 10r is disposed at the bottom end of the coil elements 10A and 10B so as to couple the coil element 10A and the coil element 10B to each other. More specifically, the wire structuring the couple portion 10r is once bent edgewise from the Y1 direction end face of the one coil element 10A in the direction of the other coil element 10B (X1 direction), and immediately thereafter bent flatwise in the coil axis direction (Y2 direction) of the one coil element 10A, to extend between the one coil element 10A and the other coil element 10B. Further, the wire is bent flatwise near the Y2 direction end face of the other coil element 10B in the direction of the other coil element 10B (X1 direction), and continues to the other coil element 10B. Thus, though the couple portion 10r is bent flatwise, the bent angle is merely approximately 90° to 120°, and the wire is not folded back by angles approximately as great as 180°. Accordingly, it is less likely that the insulation coating of the wire structuring the couple portion 10r peels off. Further, the coil used in the present embodiment can also reduce the projection amount of the couple portion 10r in the axial direction of the coil 10.

Such a couple portion 10r does not project in either height direction of the coil from the turn portions of the coil elements 10A and 10B. Therefore, the height of the reactor will not be increased by the couple portion 10r. Further, because the couple portion 10r is disposed closely to the bottom end of the coil elements 10A and 10B, a thermistor can be disposed between the coil elements 10A and 10B from above the coil elements 10A and 10B. The temperature becomes the highest in the space between the coil elements 10A and 10B when the reactor is in operation, because it is the region where the heat is radiated from both the coil elements 10A and 10B. Therefore, it is a suitable position for monitoring the temperature of the reactor for the purpose of achieving the stabilized operation of the reactor.

### <Manufacturing Method of Coil>

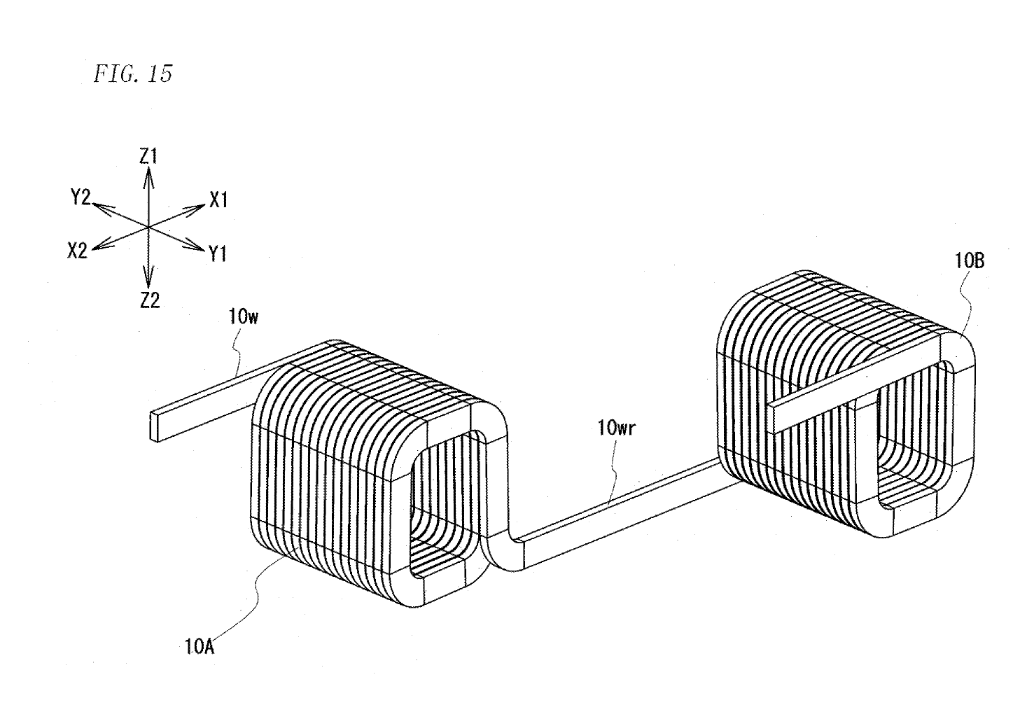

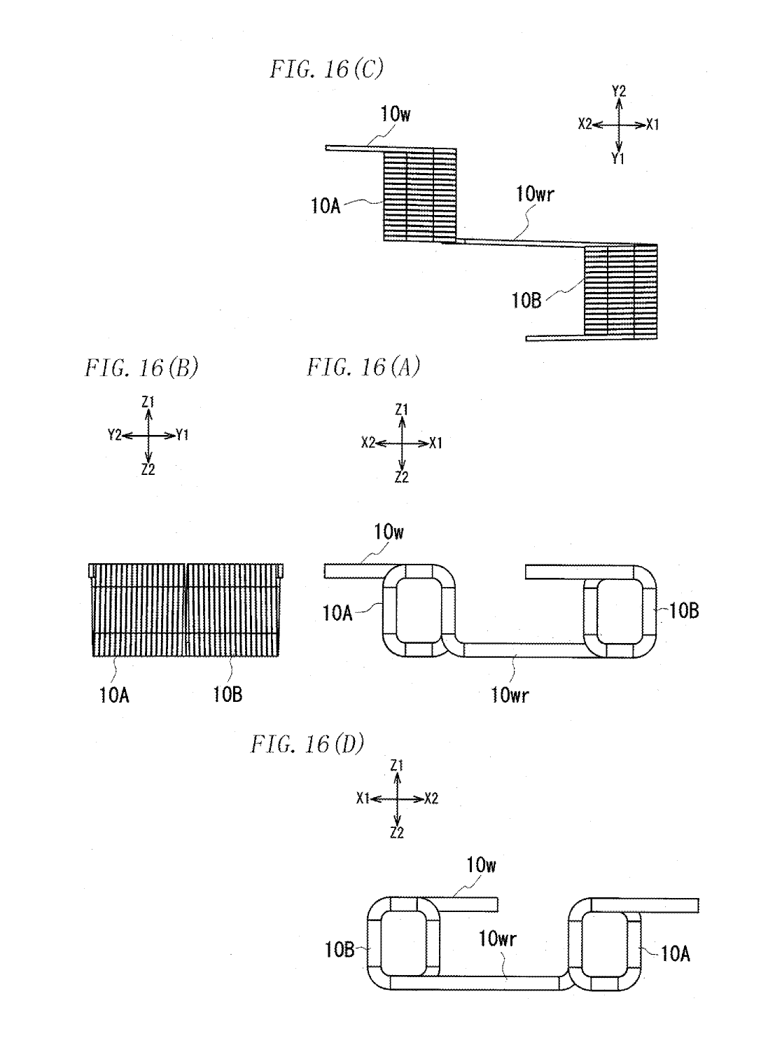

Next, with reference to FIGS. 15 and 16, a description will be given of a manufacturing method of the reactor-use coil member 1 whose description has been given above. Definitions of the directions in FIGS. 15 and 16 are the same as those in FIGS. 13 and 14. In the following, the steps of the manufacturing method will be detailed.

First, a single rectangular copper wire long enough to form the one coil element 10A, the other coil element 10B, and the couple portion 10r is prepared. The rectangular copper wire has an insulation coating such as enamel.

The one end of the rectangular copper wire is wound spirally edgewise to form the one coil element 10A. The winding direction of the one coil element 10A is counterclockwise, and its spiral progressing direction is the Y1 direction.

Next, the other end of the rectangular copper wire is wound spirally edgewise, to form the other coil element 10B with a prescribed interval from the one coil element 10A. The winding direction of the other coil element 10B is clockwise, and its spiral progressing direction is the Y2 direction. It is to be noted that the number of turns of the other coil element 10B should substantially be identical to that of the one coil element 10A.

At the stage where formation of the other coil element 10B has finished, the one coil element 10A and the other coil element 10B are coupled having a straight portion 10wr interposed therebetween, the straight portion 10wr later becoming the couple portion 10r of the coil member 1. Further, the coil element 10A and the coil element 10B are aligned with each other in terms of the height direction, and their coil axes are in parallel to each other and are displaced in the coil axis direction. Specifically, the other coil element 10B is positioned on the axially opposite side to the side of the one coil element 10A with reference to the straight portion 10wr.

Finally, the straight portion 10wr is bent flatwise by approximately 90° at two portions, one of the portions being on the one coil element 10A side and the other portion being on the other coil element 10B side. Thus, the one coil element 10A and the other coil element 10B are paralleled to each other (see FIGS. 13 and 14).

After the coil used in the present embodiment is manufactured through the foregoing steps, similarly to Embodiment 1-1 or Embodiment 2-1, the coil molded product or the core integrated type coil molded product is produced, and subsequently the annular core is formed, followed by formation of the external resin portion 40.

As has been described in the foregoing, as to the coil according to the present embodiment, the rectangular copper wire is not bent so as to be folded back. Therefore, there is little possibility of damage done to the insulation coating of the rectangular copper wire. Accordingly, using the coil, a reactor that is highly reliable even when used with a large current can be produced.

### Embodiment 5

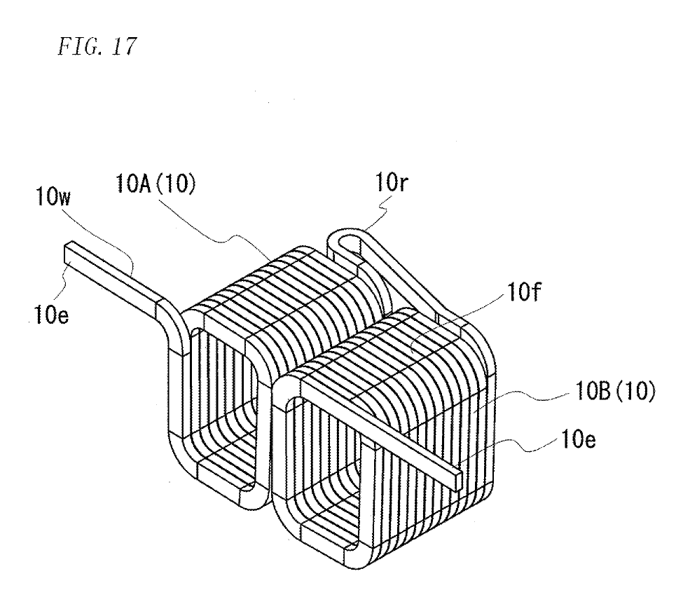

Next, with reference to FIGS. 17 to 23, a description will be given of a reactor which uses a coil in which the ends of the wire structuring the coil elements are led out sideways from the coil elements. The reactors according to the following Embodiments 5-1 to 5-7 are characterized by the shape of the coil used in each of them and, therefore, descriptions will be given of solely the coil according to each embodiment. The procedure that follow, i.e., molding of the internal resin portion, assembling of the core and the coil molded product, or assembling of the exposed core portions and the core integrated type coil molded product, and molding of the external resin portion can be carried out similarly as in Embodiments 1-1 and 2-1, and hence the description thereof will not be repeated.

### Embodiment 5-1

As shown in FIG. 17, the coil used in the present embodiment is the same as the coil used in the reactor according to Embodiment 1-1 in that paired coil elements are paralleled and are coupled via a couple portion. It is also the same as the coil according to Embodiment 1-1 in that the paired coil elements are structured with a single wire with no joined portion. However, the coil according to the present embodiment is structured such that the ends 10e of the wire 10w structuring the coil elements 10A and 10B are led out in the paralleled direction of the coil elements 10A and 10B. That is, one wire end 10e is led outward (to the left) from one coil element 10A, and the other wire end 10e is led outward (to the right) from the other coil element 10B. More specifically, the wire ends 10e are led in the horizontal direction perpendicular to the axial direction of the coil 10 on one end side of coil elements 10A and 10B being opposite to the other end side where the couple portion 10r is, and disposed at the same height as the turn-formed face 10f of the coil 10.

It is to be noted that, in the present embodiment, the couple portion 10r is raised higher than the turn-formed face 10f at the top of the coil 10. Specifically, the couple portion 10r projects higher than the turn-formed face 10f by approximately half the width of the rectangular copper wire. This structure creates an additional space under the couple portion 10r commensurate to half the width of the rectangular copper wire, as compared to a conventional coil having the couple portion 10r being flush with the turn-formed face 10f. Therefore, it becomes possible to raise, in the range of the space, the top faces of the exposed core portions 24 exposed outside the coil 10. Consequently, it becomes possible to reduce the thickness of the exposed core portions 24 (i.e., the dimension of the exposed core portions in the coil axis direction). As a result, it becomes possible to reduce the projected area of the reactor as seen from the above, while securing the volume equivalent to the conventional reactor core.

Using such a coil 10, the coil molded product or the core integrated type coil molded product is produced, and subsequently the annular core is structured, followed by molding of the external resin portion. Thus, the reactor can be structured.

In this case, the terminal block leading to the wire ends 10e can separately be deposited on the right side and the left side of the coil elements 10A and 10B at the upper portion of the coil 10. That is, this structure enhances the flexibility in designing the disposition position of the terminal block. Further, the wiring route of the wire 10w led out from the coil 10 to reach the terminal block can be shortened.

### Embodiment 5-2

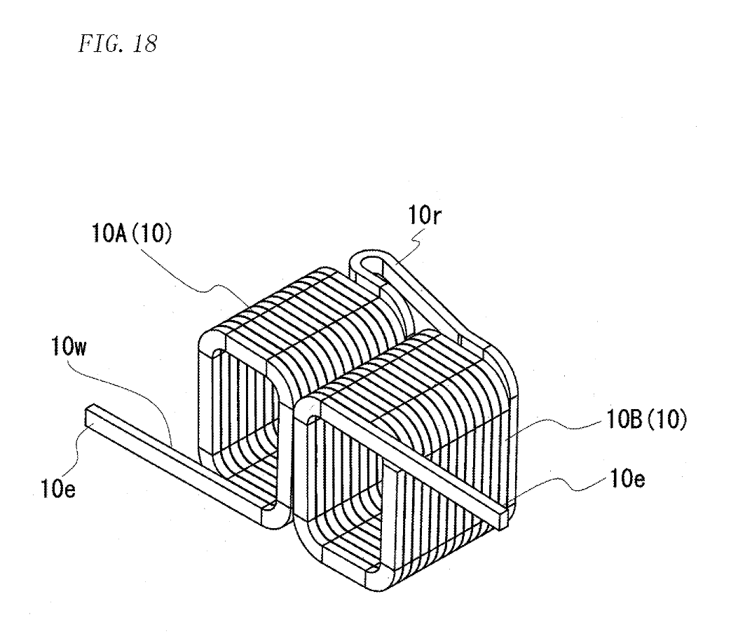

Next, with reference to FIG. 18, a description will be given of a coil according to Embodiment 5-2 which is different from Embodiment 5-1 in wire end led-out direction. The coil is the same as that according to Embodiment 5-1 in having its wire end 10e of the other coil element 10B led out rightward at the top portion of the coil 10B, but is different in having the end 10e of wire 10w of the one coil element 10A led out leftward at the bottom portion of the coil element 10A.

In the coil 10 of the present embodiment, in addition to the characteristic that the ends 10e of the wire are led out in different directions with reference to the coil 10, i.e., to the right side and to the left side, the ends 10e are also different in height. Therefore, in addition to the fact that the ends 10e of the wire can be connected to independent terminal blocks, such terminal blocks can be disposed at different heights. For example, the wire end 10e of the one coil element 10A is disposed at the bottom portion beside the coil 10, and the wire end 10e of the other coil element 10B is disposed at the top portion beside the coil 10. It also improves the flexibility in designing the wiring route of the wire 10w led out from the coil 10 to reach the terminal block.

### Embodiment 5-3

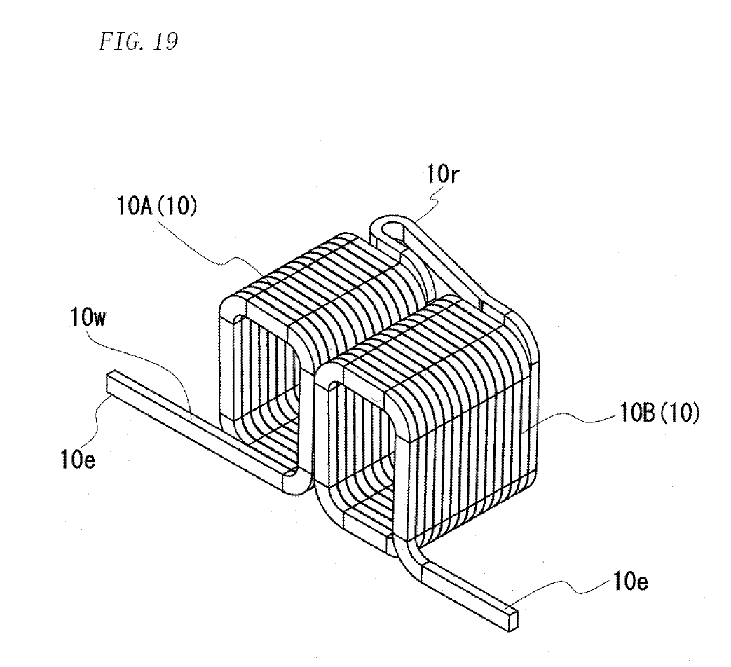

Next, with reference to FIG. 19, a description will be given of a coil according to Embodiment 5-3 which is different from Embodiment 5-2 in wire end led-out direction. The coil 10 according to the present embodiment is the same as that according to Embodiment 5-2 in having the wire end of the one coil element 10A led out leftward at the bottom portion of the coil 10A, but is different in having the wire end of the other coil element 10B led out rightward also at the bottom portion of the coil 10B.

In the coil 10 of the present embodiment, the ends 10e of the wire are led out in different directions with reference to the coil 10, i.e., to the right side and to the left side, and the ends 10e are the same in height. Therefore, in addition to the fact that the ends 10e of the wire can be connected to independent terminal blocks, the terminal blocks of the ends 10e can be disposed at the bottom portion beside the coil 10. Thus, flexibility in designing the disposition of the terminal blocks can be enhanced. This structure also improves the flexibility in designing the wiring route of the wire 10w led out from the coil to reach the terminal block.

### Embodiment 5-4

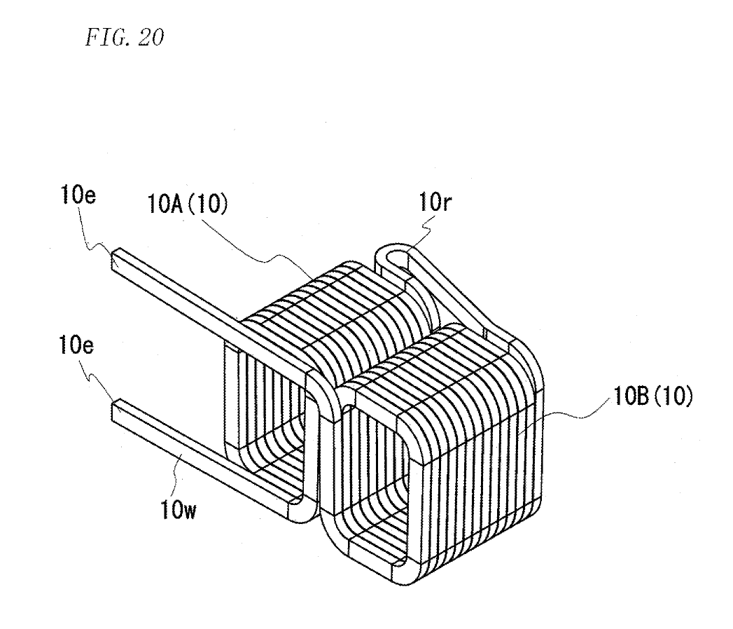

Next, with reference to FIG. 20, a description will be given of a coil according to Embodiment 5-4 which is different from Embodiment 5-2 in wire end led-out direction. The coil 10 according to the present embodiment is the same as that according to Embodiment 5-2 in having the wire end of the one coil element 10A led out leftward at the bottom portion of the coil 10A, but is different in having the wire end of the other coil element 10B led out leftward at the top portion of the coil 10B.

In the coil 10 according to the present embodiment, the ends 10e of the wire 10w are led in the same direction with reference to the coil 10, i.e., to the left side, and the ends 10e are different from each other in height. Therefore, the ends 10e of the wire can be connected to independent terminal blocks, and the terminal blocks can be paralleled in the height direction. When both the ends 10e of the wire are connected to one terminal block, it becomes possible to structure a terminal block elongated in the height direction. Thus, it becomes possible to install the terminal block even when an installation space of the terminal block is small in plane direction.

### Embodiment 5-5

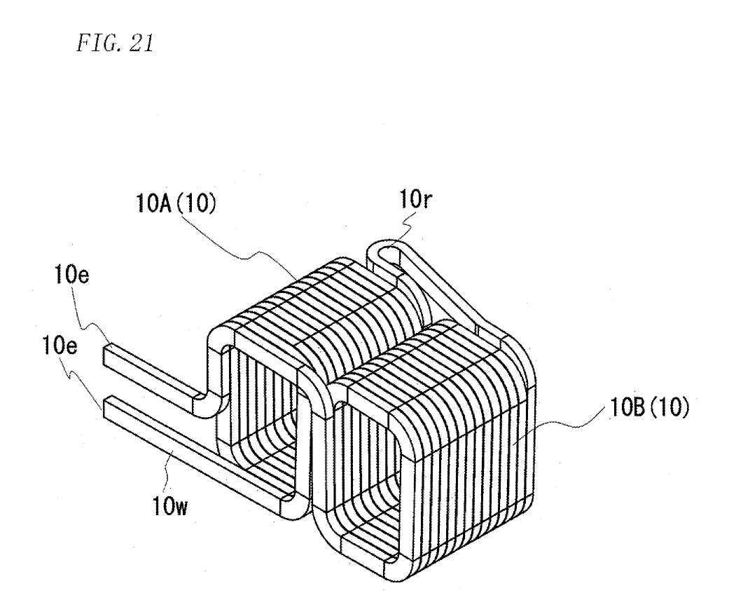

Next, with reference to FIG. 21, a description will be given of a coil according to Embodiment 5-5 which is different from Embodiment 5-4 in wire end led-out direction. The coil 10 according to the present embodiment is the same as that according to Embodiment 5-4 in having the wire end 10e of the one coil element 10A led out leftward at the bottom portion of the coil 10A and in having the wire end 10e of the other coil element 10B led out leftward relative to the coil 10B, but is different in having the wire end 10e of the other coil element 10B led out at an intermediate portion in the height direction of the coil 10B.

In the coil 10 according to the present embodiment, both the ends of the wire are led to the same direction relative to the coil 10, i.e., to the left side, in close proximity to each other while being different in height. Accordingly, similarly to Embodiment 5-4, it becomes possible to connect the ends 10e of the wire to independent terminal blocks, or to connect the ends 10e to one terminal block. Additionally, it becomes possible to reduce the installation space of the terminal block in height direction.

### Embodiment 5-6

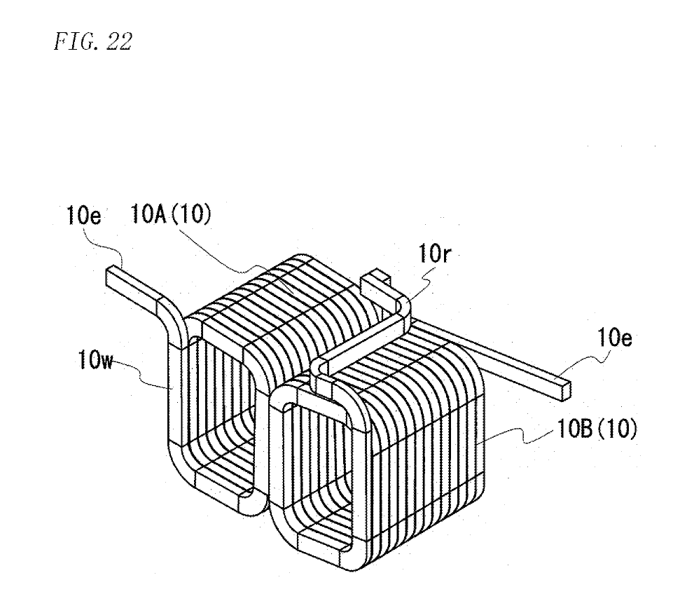

Next, with reference to FIG. 22, a description will be given of a coil in which the couple portion is positioned at the top portion of the coil, and the wire ends are led out frontward and rearward in terms of the axial direction of the coil. In the coil 10 according to the present embodiment, the paired paralleled coil elements 10A and 10B have their respective winding directions reverse to each other, and the coil elements 10A and 10B are structured with separate wires. That is, the one coil element 10A is structured left-handed from its one end (front side) to the other end (rear side), while the other coil element 10B is structured right-handed from its one end (front side) to the other end (rear side). Further, the couple portion 10r of the coil 10 extends across the other end of the one coil element 10A to the one end of the other coil element 10B, and is structured by welding the ends 10e of the wires respectively structuring the coils 10A and 10B. Specifically, at the other end of the one coil element 10A, the wire 10w is raised upward on the right side of the coil 10A. On the other hand, at the one end of the other coil element 10B, the wire 10w raised upward on the right side of the coil 10B is bent edgewise substantially at a right angle, so as to extend substantially to the left side of the other coil element 10B. Subsequently, the wire 10w is bent flatwise substantially at a right angle, so as to extend to the other end of the other coil element 10B. The wire 10w is further bent flatwise substantially at a right angle, so as to extend on the top portion of the turn of the one coil element 10A. Then, the other wire end of the wire of the one coil element 10A and the wire end of the other coil element 10B that is routed from the one end to the other end of the coil are overlaid on each other to be welded.

In the coil 10, the wire end of the one coil element 10A is led out to the left side of the coil 10A at the top portion of the one end of the coil element 10A, while the wire end of the other coil element 10B is led out to the right side of the coil 10B at the top portion of the other end of the coil element 10B.

With such a coil 10, it becomes possible to lead out the ends 10e of the wire of the coil 10 rightward and leftward, and additionally, to lead out them also from frontward and rearward displaced positions relative to the coil 10. Thus, flexibility in designing the disposition of the terminal blocks connected to the ends of the wire can be enhanced. Further, with this structure, because the coil elements 10A and 10B can be formed independently of each other and the couple portion 10r can be formed by welding, the wires 10w can easily undergo bending work to be formed into the coil elements 10A and 10B.

### Embodiment 5-7

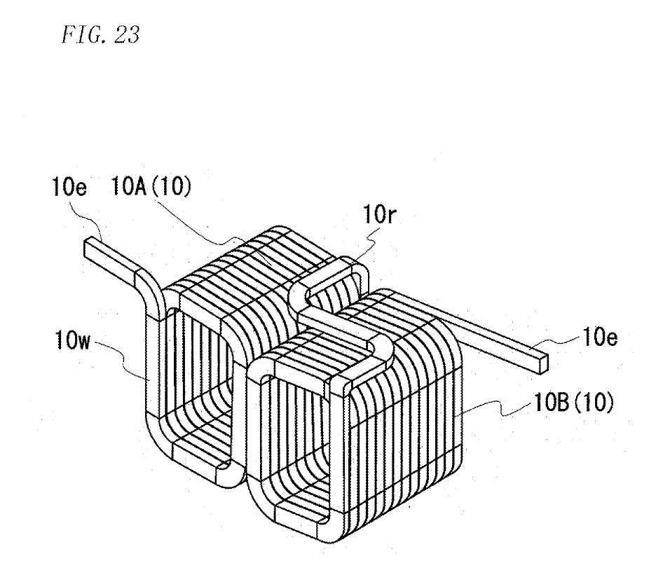

Next, with reference to FIG. 23, a description will be given of a coil in which the couple portion is positioned at the top portion of the coil, but the coil is structured with a single wire. The coil 10 according to the present embodiment is the same as the coil shown in FIG. 22 in that paired and paralleled coils 10A and 10B have their respective winding directions reverse to each other. However, the coil 10 according to the present embodiment is different from the coil shown in FIG. 22 in that both the coil elements 10A and 10B are structured with a continuous wire. Specifically, at the other end of one coil element 10A, the wire 10w that is raised from the right side of the coil element 10A is bent flatwise substantially at a right angle, so as to extend to an intermediate position in the axial direction of the one coil element 10A at the top portion of the turn of the coil element 10A. Next, the wire 10w is bent edgewise substantially at a right angle, so as to extend on the other coil element 10B to reach the right end of the coil 10B, where it is again bent edgewise substantially at a right angle, so as to extend to the top right end at the one end of the other coil element 10B. Subsequently, the wire 10w is bent flatwise substantially at a right angle so as to extend downward, to start forming the turn of the other coil element 10B.

In the coil 10 also, the wire end of the one coil element 10A is led out to the left side of the coil element 10A at the top portion of the one end of the coil element 10A, while the wire end of the other coil element 10B is led out to the right side of the coil 10B at the top portion of the other end of the coil element 10B.

With such a coil 10, it becomes possible to lead out the ends 10e of the wire 10w of the coil 10 rightward and leftward, and additionally, to lead out them also from frontward and rearward displaced positions relative to the coil 10. Thus, flexibility in designing the disposition of the terminal blocks connected to the ends 10e of the wire can be enhanced. Further, with the coil 10 according to the present embodiment, it is not necessary to weld and couple the individual coil elements 10A and 10B.

### Embodiment 6

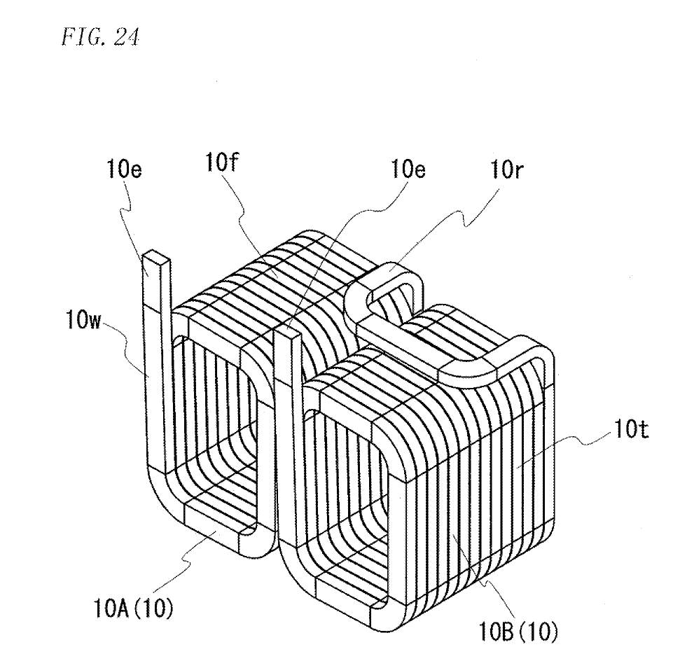

Next, with reference to FIG. 24, a description will be given of a coil that can be used in the reactor according to the Embodiments 1-1 and 2-1, and whose couple portion is disposed at the top of the turn portion of the coil. The coil 10 is different from the coil shown in FIG. 3 in that, when the coil is seen two-dimensionally, the couple portion 10r of the coil is overlaid on the turn portion 10t. The rest of the structure is the same as the coil shown in FIG. 3 and, therefore, the following description will be given focusing on the difference.

The couple portion 10r of the coil according to the present embodiment is structured as follows. First, in FIG. 24, the side where the wire ends 10e are positioned is defined as one end side, and the side where the couple portion 10r is positioned is defined as the other end side. The wire 10w of the one coil element 10A raised upward is bent on the other end side flatwise substantially at a right angle so as to overlay on the turn portion 10t of the coil element 10A, to extend toward the one end side of the coil. Next, the wire is bent edgewise substantially at a right angle to extend toward the other coil element 10B. The wire 10w is again bent edgewise substantially at a right angle to extend toward the other end side of the coil. Subsequently, the wire 10w is bent flatwise substantially at a right angle, to extend downward. This wire 10w extending downward starts forming the other coil element 10B.

With this structure, when the reactor is seen two-dimensionally, because the couple portion 10r is overlaid on the coil elements 10A and 10B with an interval therebetween, the couple portion 10r will not project in the axial direction of the paired coils 10A and 10B. Therefore, when the exposed core portions are joined to the internal core portions after a coil molded product or a core integrated type coil molded product is produced using the coil, the top face of the exposed core portions can be set to any height as being free of interference of the couple portion 10r.

That is, with the coil according to the present embodiment also, similarly to Embodiment 1-1, it is not necessary for the top and bottom faces of the internal core portions and the top and bottom faces of the exposed core portions to be flush with each other. This makes it possible to allow the top faces of the exposed core portions to project higher than the top faces of the internal core portions, to provide a great height to the exposed core portions. Thus, a reactor having a small projected area can be structured. It goes without saying that it is also possible to allow the bottom faces of the exposed core portions to project lower than the bottom faces of the internal core portions.

Further, with the coil 10 according to the present embodiment, because the width direction of the rectangular copper wire structuring the couple portion 10r is arranged so as to conform to the turn-formed face 10f, the height of the couple portion 10r projecting above the turn-formed face can also be suppressed.

### Embodiment 7

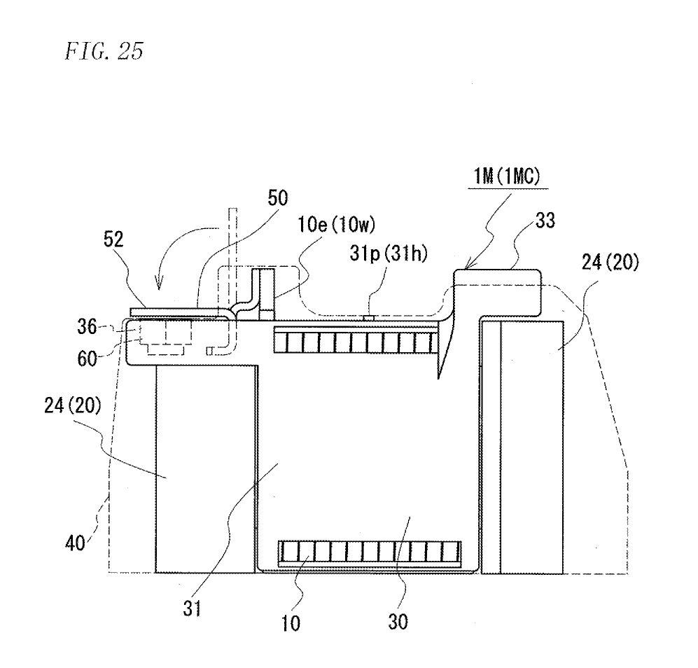

Next, with reference to FIG. 25, a description will be given of a reactor in which a terminal block is formed by molding of the internal resin portion. The major difference lies in that, the terminal block is formed by molding of the external resin portion according to Embodiment 1-1, whereas the terminal block is formed by molding of the internal resin portion 30 according to the present embodiment. The rest of the structure is substantially the same as Embodiment 1-1. Accordingly, the following description will be given focusing on the difference.

Schematically, a coil molded product 1M or a core integrated type coil molded product 1MC according to the present embodiment corresponds to the coil molded product 1M or the core integrated type coil molded product 1MC according to Embodiment 1-1 or 2-1 being modified such that the internal resin portion 30 extends under the connection faces 52 of the terminal fittings. That is, before the internal resin portion 30 is molded over the coil, or when the internal resin portion is molded over the coil 10 and the exposed core portions 24, the terminal fittings 50 are previously welded to the ends 10e of the wire structuring the coil 10. Subsequently, the internal resin portion 30 is molded such that the terminal fittings except for their respective connection faces 52 and weld faces 54 are buried in the internal resin portion 30, and that the nut accommodating holes 36 for accommodating the nuts 60 are simultaneously formed. Thereafter, in a case where the coil molded product 1M is to be formed, the internal core portions and the exposed core portions 24 are combined; in a case where the core integrated type coil molded product 1MC is to be formed, the exposed core portions 24 are combined, and the external resin portion 40 is further molded. Here, the external resin portion 40 is molded so as to avoid intrusion of the resin structuring the external resin portion 40 into the nut accommodating holes 36 while maintaining the connection faces 52 and the weld faces 54 of the terminal fittings in parallel to each other. After the external resin portion 40 is molded, similarly to Embodiment 1-1, the nuts 60 are accommodated in the nut accommodating holes 36, and thereafter the connection faces 52 are bent approximately by 90°, to overhang the openings of the nut accommodating holes 36.

With the structure according to the present embodiment, because the terminal fittings 50 can also be handled as the members integrated with the coil 10 (internal core portion), the manufacture of the reactor can be facilitated.

### Embodiment 8

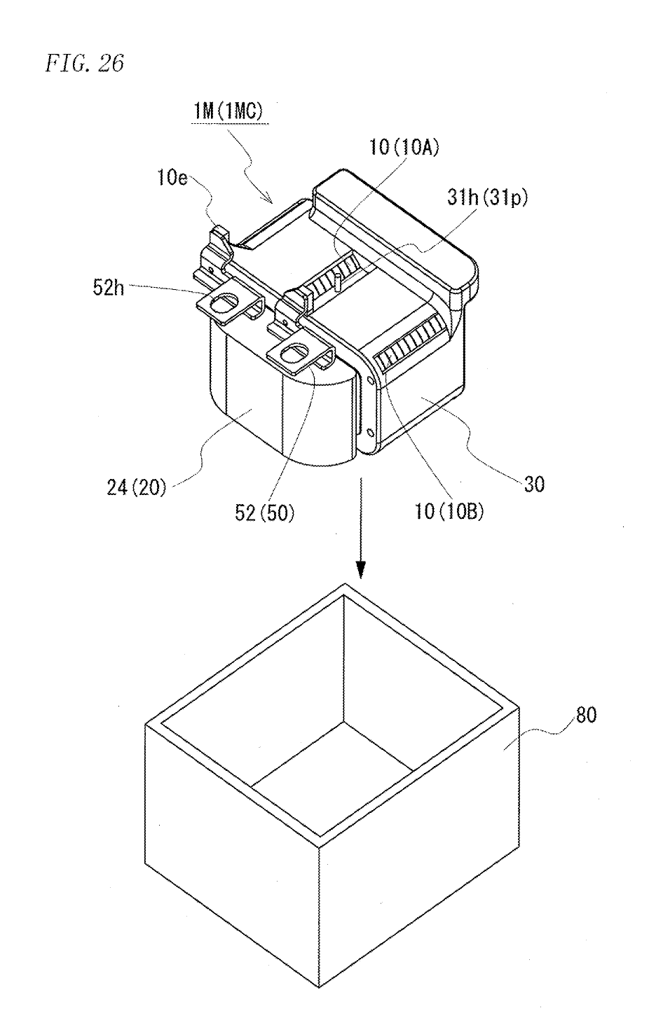

Next, with reference to FIG. 26, a description will be given of a reactor using a case. The reactor is assembled in the following manner.

In the present embodiment, first, the coil molded product 1M according to Embodiment 1-1 or the core integrated type coil molded product 1MC according to Embodiment 2-1 is prepared. An alumina powder-dispersed epoxy resin is employed for the internal resin portion 30. Next, in the former case, an assembled product being the combination of the coil molded product 1M, the internal core portions, the exposed core portions 24 and the terminal fittings 50 is produced; in the latter case, an assembled product being the combination of the core integrated type coil molded product 1MC, the exposed core portions 24 and the terminal fittings 50 is produced.

Then, the assembled product is accommodated in a case 80. The case 80 is made of aluminum alloy. The case 80 is a rectangular container which has front, rear, right, and left sidewalls and a bottom face, and has its top opened. As the assembled product is accommodated in the case 80, the bottom faces of the exposed core portions 24 and the bottom face of the internal resin portion 30 are brought into contact with the bottom face of the case 80, whereby the assembled product is held in the case 80.

After the assembled product is accommodated in the case 80, space between the case 80 and the assembled product is filled with a potting resin to be the external resin portion (not shown). In the present embodiment, polyurethane is used as the external resin portion. Because polyurethane is superior to epoxy resin in shock resistance, the assembled product in the case 80 can fully be protected. Further, this structure of the reactor achieves a reduced weight and cost-effectiveness as compared to a structure in which the entire external resin portion is made of epoxy resin or ceramic filler-containing epoxy resin.

With the structure of the present embodiment, use of the coil molded product 1M (core integrated type coil molded product 1MC) facilitates assembling of the reactor. Additionally, use of the case 80 can secure protection of the coil 10 and the core 20 structuring the assembled product, and can achieve efficient heat dissipation through the case 80 which exhibits high heat conductivity.

It is to be noted that, in a case where the reactor is structured using the coil whose wire ends are led out sideways from the coil (see Embodiment 5) and the case, in order to make it easier for the ends of the wire to be led out, preferably, the case includes the bottom face, and the front and rear sidewalls facing the exposed core portions, and no right and left faces. That is, the case should be the one whose top, right and left sides are open. It goes without saying that the case may include the right and left faces, and the right and left faces may be provided with lead-out holes or lead-out grooves for leading out the ends of the wire from the inside of the case to the outside.

### Reference Example 1

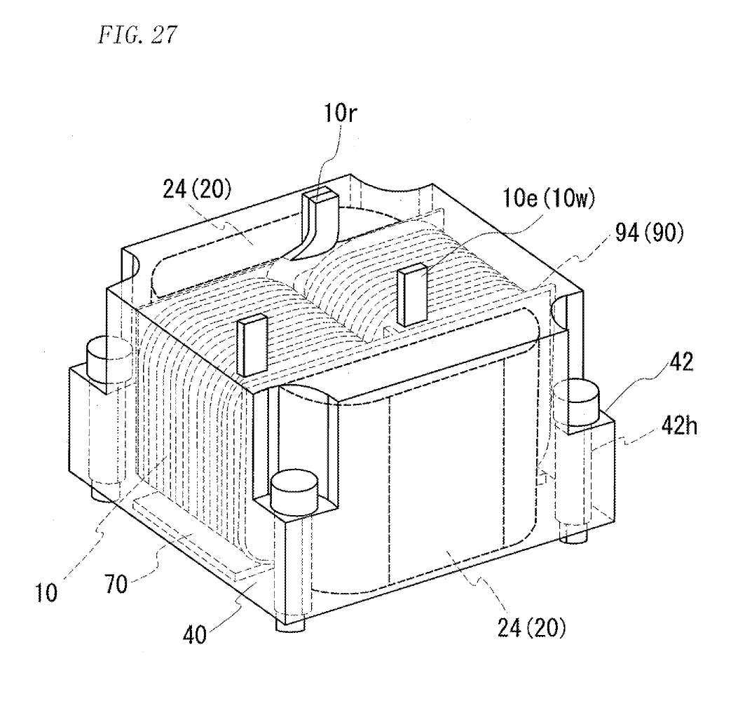

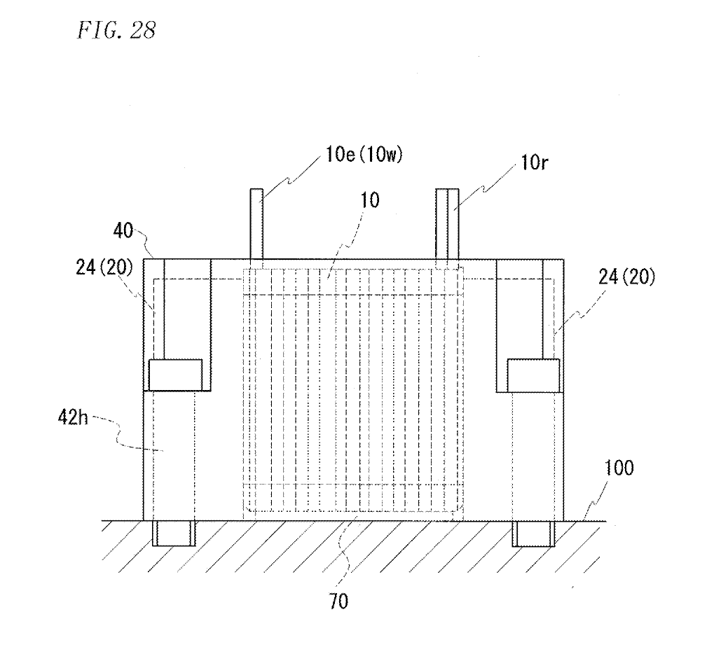

In the foregoing description, the reactor-use component and the reactor of the present invention is predicated on use of the internal resin portion. However, the reactor can be structured dispensing with the internal resin portion and using the external resin portion solely. In the present example, with reference to FIGS. 27 and 28, a description will be given of a reactor in which the internal resin portion is dispensed with and in which a heatsink is integrated by the external resin portion.

The reactor 1 is the same as that according to Embodiment 1-1 in including the coil 10 in which the paired coil elements 10A and 10B are coupled in parallel to each other via the couple portion 10r, and the annular core 20. However, the coil elements 10A and 10B are separately produced from independent wires being wound, and the ends 10e of the wire 10w structuring each coil element are led upward at the end of the coil 10. Of the wire ends 10e, the wire ends 10e positioned on the one end side of the coil elements 10A and 10B are joined to each other by welding, to form the couple portion 10r.

On the other hand, similarly to the core according to Embodiment 1-1, the core 20 includes a pair of internal core portions inserted into the coil 10, and the exposed core portions 24 that are exposed outside the coil elements 10A and 10B and connect between the end faces of the internal core portions to form the annular core 20.

Instead of the internal resin portion, a bobbin 90 is used. Normally, between the coil 10 and the core 20, that is, between each internal core portion and the coil 10, a sleeve-like bobbin (not shown) made of an insulating material is interposed. For example, a square pipe is formed by combining a pair of square bracket-shaped plastic molded products, and each internal core portion is externally covered by the sleeve-like bobbin thus obtained. The sleeve-like bobbin functions to coaxially position the coil 10 and the core 20, and to secure insulation between the core 20 and the coil 10. Also used is a frame-like bobbin 94 which is fitted to the outside of the internal core portions, so as to interpose between the exposed core portions 24 and the coil end faces. This frame-like bobbin 94 holds the ends of the coil 10 and also contributes toward securing insulation between the coil 10 and the exposed core portions 24. Such a bobbin 90 may be made of an insulating material such as polyphenylene sulfide (PPS), polytetrafluoroethylene (PTFE), liquid crystal polymer (LCP) or the like.

Further, a heatsink 70 is disposed at the bottom face (i.e., the install face) of the coil 10 so as to be in contact therewith. The heatsink 70 according to the present embodiment is a plate member made of silicon nitride (27 W/m·K) which has an area wide enough to entirely cover the bottom faces of both the coil elements 10A and 10B. In the present embodiment, the heatsink 70 is fixed to the coil 10 by use of an adhesive exhibiting an excellent heat conductivity (a sheet-like heat conductive epoxy adhesive (5 W/m·K) available from Nagase ChemteX Corporation), so as not to peel off from the coil 10. In this fixed state, the bottom face of the heatsink 70 (the face facing the cooling base) and the bottom faces of the exposed core portions 24 are flush with each other.

The assembled product being the combination of the coil 10, the core 20 and the bobbin 90 is covered by the external resin portion 40. The external resin portion 40 may be the resin as in the Embodiment 1-1, or may be the resin similar to the internal resin portion. In the present embodiment, the outer circumference of the assembled product except for the coil wire ends 10e, the couple portion 10r and the bottom face of the assembled product is covered by the external resin portion 40. The external resin portion 40 is formed by: producing the assembled product of the core 20 and the coil 10; fixing the heatsink 70 to the bottom face (i.e., the install face) of the coil 10 and disposing the resultant coil 10 in the mold; and thereafter carrying out injection molding of the epoxy resin. It is to be noted that, the face of the heatsink 70 facing the cooling base 100 and the bottom faces of the exposed core portions 24 are not covered by the external resin portion 40, and are exposed.

The external resin portion 40 is in a shape of rectangular parallelepiped. The top portions of all the corners of the external resin portion 40 are cut off, whereby flange portions 42 are formed at the rest bottom portions. At each of the flange portions 42, a through hole 42h is formed, into which a bolt (tightening member) for fixing the reactor 1 to the cooling base 100 is inserted.

As shown in FIG. 28, the reactor 1 structured as described in the foregoing can be mounted on the cooling base 100 by: positioning the through holes 42h of the flange portions to the screw holes formed at the cooling base 100; and inserting the bolts into the through holes 42h to be screwed to the screw holes. Here, application of grease or the like to the bottom face of the heatsink 70 or the surface of the cooling base 100 to create a coating film achieves an excellent adhesion between the heatsink 70 and the cooling base 100, and thus it is preferable.

Such a reactor 1 can achieve the following effects.

Because the structure does not require any case and is to directly be mounted on the cooling base 100, it is small in size and in weight. Further, because the heatsink 70 exhibiting a high heat conductivity is interposed between the coil 10 and the cooling base 100, the structure exhibits an excellent heat dissipation performance.

Because the bottom face of the heatsink 70, the bottom faces of the exposed core portions and the bottom face of the external resin portion 40 are flush with one another, the heat of the core 20 can efficiently be transferred to the cooling base 100. Thus, an excellent heat dissipation performance is exhibited.

Thanks to the provision of the external resin portion 40, a variety of effects such as follows can be achieved: (1) the core 20, the coil 10, and the heatsink 70 can integrally be handled; (2) the heatsink 70 can surely be fixed to the coil 10; (3) the core 20 can be reinforced; (4) the core 20 and the coil 10 can be protected from the external environment; and (5) an insulation against the peripheral members can be secured.

Additionally, because the reactor 1 includes the flange portions 42 integrated with the external resin portion 40, it can easily be mounted on the cooling base 100 without the necessity of using separate fixing members. It is to be noted that, in the external resin portion 40, while the resin around the flange portions 42 is thick, such thick regions are limited to the four corners on the outer circumference of the reactor 1, and the flange portions 42 as a whole are thin. Accordingly, any reduction in heat dissipation performance due to the presence of the flange portions 42 can be suppressed.

In Reference Example 1 described above, the bolts are inserted into the through holes 42h of the flange portions 42 to thereby fix the reactor to the cooling base 100. On the other hand, reactor mounting members may be used instead of such a fixing structure. These mounting members each include, for example, a pair of leg pieces fixed to the cooling base, and a couple piece connecting between the leg pieces. Fixation of the reactor should be carried out by use of the mounting member so as to hold the faces of the exposed core portions opposite to the install face (in FIG. 27, the top faces) by respective corresponding couple pieces, and such that the pairs of leg pieces are positioned on either side of the exposed core portions. In particular, in a case where each couple piece itself is an arc-shaped elastic piece that is bowed toward the install face, the exposed core portions can effectively be pressed against the cooling base.

### Reference Example 2

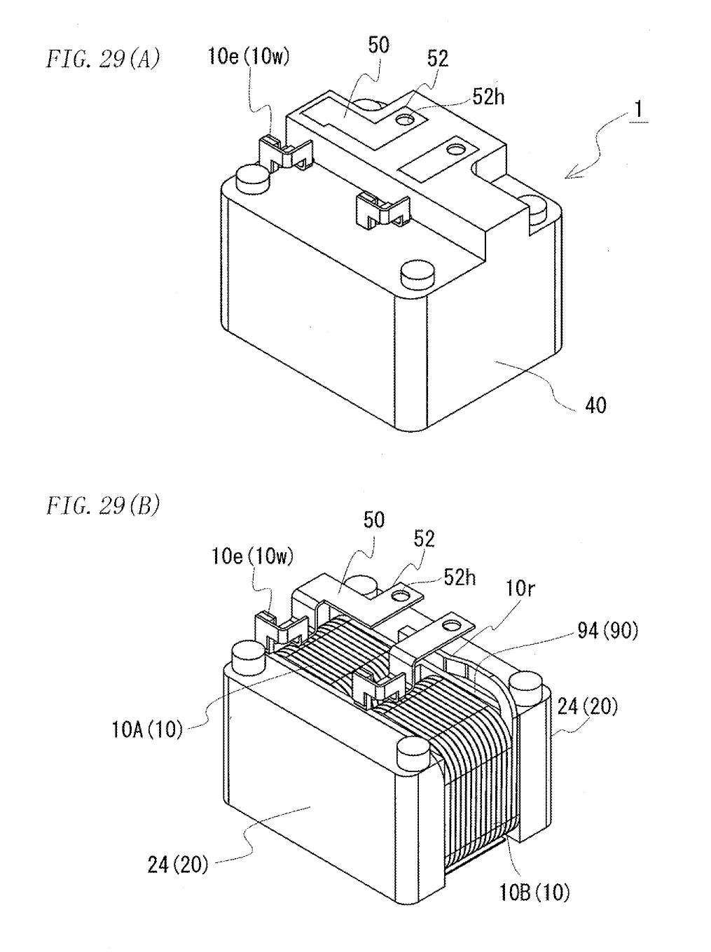

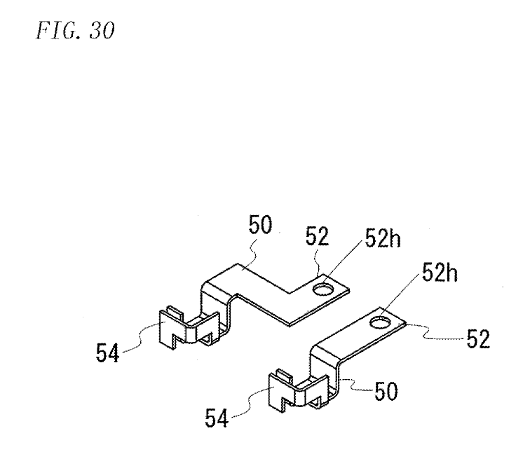

Next, with reference to FIGS. 29 and 30, a description will be given of a reactor in which the internal resin portion is dispensed with and in which the terminal fittings are integrated by molding of the external resin portion.

The reactor 1 according to the present example is the same as that according to Reference Example 1 in being constituted of the coil 10 having the pair of coil elements 10A and 10B, the annular core 20, the bobbin 90, and the external resin portion 40, but is different from Reference Example 1 in that the terminal fittings 50 are integrated with the external resin portion 40 (FIG. 29 (A)). Further, the present example is different from Embodiment 1-1 in having no internal resin portion.

In more detail, in the assembled product made up of the core 20 and coil 10 before integrated by molding of the external resin portion 40, as shown in FIG. 29 (B), the ends 10e of the wire 10w structuring the coil elements 10A and 10B and the terminal fittings 50 are connected to each other. The terminal fittings 50 are, as shown in FIG. 30, each formed by bending work of a sheet-metal material. Specifically, the terminal fittings 50 each include a substantially L-shaped or rectangular connection face 52 on one end side, and a weld face 54 on the other end side that is formed by a branched metal piece being bent so as to clamp the wire end. The connection face 52 and the end of the weld face 54 are arranged at substantially the same height, and a buried portion bent downward is formed at an intermediate portion between them. Such terminal fittings 50 each having a three-dimensional shape have their respective buried portions buried in the external resin portion 40 when the external resin portion 40 is molded, whereby the fixed state is stabilized.

On the other hand, in a state where the external resin portion 40 is molded, the terminal block is integrated with the top face of the reactor 1, the wire ends 10e of the coil elements 10A and 10B and the weld faces 52 of the terminal fittings 50 are projecting from a flat face at a lower level than the terminal block (FIG. 29 (A)). In this manner, by exposing the joined portions of the wire ends 10e and the weld faces 54 outside, the heat dissipation performance of the joined portions can be improved.

In the present example also, the top and bottom faces of the exposed core portions 24 are structured so as to project upward and downward relative to the top face of the internal core portion, and in particular, such that the bottom faces of the exposed core portions 24 are brought into contact with the cooling base. It is to be noted that, bolt holes (not shown) for inserting bolts for fixing to the cooling base through which coolant circulates (not shown) are formed at the four corners of the exposed core portions 24 as a whole.

As to such a reactor 1, the coil 10, the core 20 and the bobbin 90 are combined, and the terminal fittings 50 are welded to the coil wire ends to obtain the assembled product. The assembled product is accommodated in the mold, which is filled with the resin for structuring the external resin portion 40, to mold the external resin portion 40. It is to be noted that welding of the wire ends 10e and the terminal fittings 50 may be carried out after the external resin portion 40 is molded. In such a case, terminal fittings 50 should each be held at a prescribed position by use of the mold for molding the external resin portion 40.

This structure makes it possible to mold the entire reactor including the terminal block at once by the external resin portion 40. Accordingly, the reactor 1 that exhibits excellent shock resistance and corrosion resistance can be obtained by efficient molding. Further, because fixing members or the like for fixing the terminal block to the core 20 or the coil 10 are not required, a reduction in the number of components can be achieved. This can realize a reduction both in size and weight, whereby a reduction in costs can also be achieved.

It is also possible to accommodate the assembled product shown in FIG. 29 (B) in a case (not shown), and fill space between the case and the assembled product with resin, to thereby obtain the external resin portion. In such a case also, the case can be integrated with the assembled product by molding of the external resin portion.

In particular, in a case where accommodating the assembled product in such a case (not shown), the resin molding may be carried out by two steps, as follows. For example, before integrally formed by molding of the external resin portion 40, by carrying out insert molding by an appropriate resin material (second resin) so as to have, for example, the terminal fittings 50 formed in a shape close to a terminal block, to thereby form a preliminary molded product (not shown). Subsequently, the preliminary molded product is disposed at a prescribed position in the assembled product made up of the core 20 and the coil 10, and thereafter accommodating the same in the case. Further, the resin structuring the external resin portion is injected into the case. Thus, the preliminary molded product and the assembled product are integrated by the molding of the external resin portion 40.

Because such a molding manner of integration of the reactor 1 through use of the preliminary molded product eliminates the troublesome work step of assembling the mold on the case, the manufacture of the reactor 1 becomes easier. There is an additional advantage that, even when there exists any portion having a complicated shape, for example in close proximity to the terminal fittings 50 of the preliminary molded product, the second resin can previously and reliably be injected to such a portion. The second resin used for molding the preliminary molded product may be of the resin material identical to or different from that of the external resin portion 40.

### Reference Example 3

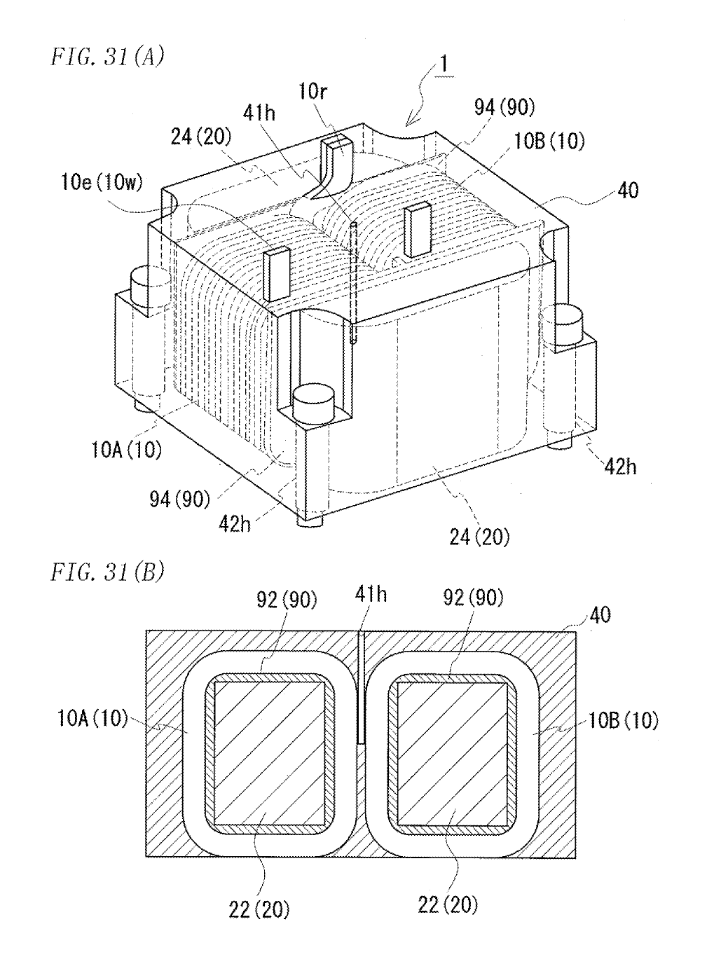

Next, with reference to FIG. 31, a description will be given of a reactor in which the internal resin portion is dispensed with and in which the sensor-use hole of the temperature sensor is formed by molding of the external resin portion.

The basic mode of the reactor is the same as that according to Reference Example 1. The present example is different from Reference Example 1 in that it has no heatsink and the sensor-use hole 41h is formed at the external resin portion 40.

Such a reactor 1 can be structured as follows. An assembled product is previously produced by combining the coil 10, the bobbin 90 (92, 94) and the core 20. Then the assembled product is disposed in a mold, and resin such as epoxy resin is injected into the mold. Thus, the circumference of the assembled product can be covered by the external resin portion 40.

In the step of molding the external resin portion 40, at a portion where the sensor-use hole 41h should be formed, that is, between a pair of coil elements 10A and 10B, an appropriate thin rod-like inner mold is disposed in the mold. Removal of the inner mold after the molding of the external resin portion 40 leaves the sensor-use hole 41 at the top face of the external resin portion 40. It is to be noted that the shape of the sensor-use hole 41h can be selected as appropriate in accordance with the shape of the sensor.

The reactor 1 structured as described above is small in size and weight by dispensing with the case, while is capable of electrically and mechanically protect the assembled product, thanks to the provision of the external resin portion 40. Further, the reactor 1 is provided with the sensor-use hole 41h for disposing a sensor for measuring the physical quantity of the reactor. The insertion of any desired sensor (e.g., a thermistor for measuring the temperature) into the sensor-use hole 41h realizes positioning of the desired sensor with ease. In particular, because the reactor 1 is structured such that the sensor-use hole 41h is formed simultaneously with the molding of the external resin portion 40, and the sensor is disposed after the molding, it is unlikely that any damage is done to the coil 10 or the core by the formation of the sensor-use hole 41h. Further, the formation of the sensor-use hole 41h simultaneously with the molding of the external resin portion 40 facilitates positioning of the sensor-use hole 41h, and allows the sensor-use hole 41h to be formed with ease. Thus, the manufacturability of the reactor is excellent.

The present invention is not limited to the modes for carrying out the invention described in the foregoing, and can be modified as appropriate within a range not deviating from the gist of the present invention.

### INDUSTRIAL APPLICABILITY

The reactor of the present invention can be used as a component for a converter or the like. In particular, it can suitably be used as an automobile-use reactor, including hybrid vehicles and electric vehicles. The reactor-use component of the present invention can be used in manufacturing the reactor.

### REFERENCE SIGNS LIST

1: Reactor
1M: Coil molded product
1MC: Core integrated type coil molded product
10: Coil
10A, 10B: Coil element
10w: Wire
10t: Turn portion
10f: Turn-formed face
10r: Couple portion
10wr: Straight portion
10e: End (wire end)
20: Core
22: Internal core portion
22c: Core piece
22g: Gap member
24: Exposed core portion
30: Internal resin portion
31: Turn covering portion
33: Couple portion covering portion
30h: Hollow bore
31h: Sensor-use hole
31p: Sensor storing pipe
35: Flange portion
35h: Through hole
35c: Metal collar
36: Nut accommodating hole
40: External resin portion
41h: Sensor-use hole
31p: Sensor storing pipe
42: Flange portion
42h: Through hole
42c: Metal collar
43: Nut accommodating hole
50: Terminal fitting
52: Connection face
52h: Insertion hole
54: Weld face
60: Nut
70: Heatsink
80: Case
90: Bobbin
92: Sleeve-like bobbin
94: Frame-like bobbin
100: Cooling base
200: Mold
210: First mold
210A: End plate
210B: Inner mold
220: Second mold
220A: End plate
220B: Sidewall
230: Rod-like element

1. A reactor-use component for structuring a reactor including a coil formed with a pair of paralleled coil elements made of a spirally wound wire and a core fitted into the pair of coil elements to form an annular shape, the reactor-use component comprising:
an internal resin portion that retains a shape of said coil; and
hollow bores formed by a part of said internal resin portion for fitting said core to inner circumferences of said coil elements.

2. The reactor-use component according to claim 1, further comprising
internal core portions being part of said core, said internal core portions being inserted into said hollow bores and being integrated with said internal resin portion, wherein
said internal core portions have their respective opposite ends exposed outside said internal resin portion.

3. The reactor-use component according to one of claims 1 and 2, further comprising
terminal fittings each connected to an end of the wire, said terminal fittings being integrated by molding of said internal resin portion.

4. The reactor-use component according to one of claims 1 and 2, wherein
a sensor-use hole for accommodating a sensor for measuring a physical quantity of the reactor is formed by molding in said internal resin portion.

5. The reactor-use component according to claim 3, further comprising:
a nut accommodating hole that is formed by molding of said internal resin portion and that has a polygonal cross section; and
a nut that has a polygonal outer shape and that is accommodated in said nut accommodating hole, wherein
said terminal fittings each have an insertion hole for a bolt to be screwed with said nut,
said terminal fittings are each bent to thereby overhang an opening of said nut accommodating hole so as to allow said bolt to be inserted through the insertion hole and to be screwed with the nut, and to thereby prevent said nut from coming off from said nut accommodating hole.

6. The reactor-use component according to one of claims 1 and 2, wherein
said coil is structured with a continuous wire, and includes a couple portion coupling said pair of coil elements to each other, and
said couple portion projects toward an outside of a turn portion of said coil elements relative to a turn-formed face formed by the turn portion.

7. The reactor-use component according to one of claims 1 and 2, wherein
said coil is structured with a continuous wire, and includes a couple portion coupling said pair of coil elements to each other, and
an axial direction of each of the coil elements starting from ends of the wire structuring the coil elements toward said couple portion is defined as a spiral progressing direction of each of the coil elements, and a direction perpendicular to both a paralleled direction of said pair of coil elements and an axial direction of said pair of coil elements is defined as a height direction of the coil, wherein
said pair of coil elements have their respective spiral progressing directions arranged so as to be opposite to each other's, and
said couple portion is disposed between said pair of coil elements without projecting in the height direction relative to said pair of coil elements.

8. The reactor-use component according to one of claims 1 and 2, wherein
when said reactor-use component is used as the reactor, a heatsink integrated with the internal resin portion is provided to an install face of said reactor-use component facing a reactor fixation target.

9. The reactor-use component according to one of claims 1 and 2, wherein
the ends of the wire structuring said coil elements are led out sideways from said coil elements.

10. A reactor comprising a coil formed with a pair of paralleled coil elements made of a spirally wound wire and a core fitted into the pair of coil elements to form an annular shape, the reactor further comprising:
an internal resin portion that retains a shape of said coil; and
hollow bores formed by a part of said internal resin portion for fitting said core to inner circumferences of said coil elements, wherein
said core includes internal core portions fitted into said hollow bores and exposed core portions that are integrated with said internal core portions and that are exposed outside said hollow bores.

11. The reactor according to claim 10, wherein
said internal core portions are integrated with said internal resin portion.

12. The reactor according to one of claims 10 and 11, further comprising
an external resin portion that integrates said core and said internal resin portion.

13. The reactor according to claim 12, wherein
said exposed core portions of said core are each made of a powder magnetic core, wherein
a face of each of constituent members of said reactor facing a reactor fixation target is defined as an install face, wherein
the install face of said internal resin portion and the install faces of said exposed core portions are both exposed outside said external resin portion and are flush with each other.

14. The reactor according to claim 12, wherein
a resin structuring said internal resin portion is higher in heat conductivity than a resin structuring said external resin portion, and
the resin structuring said external resin portion is higher in shock resistance than the resin structuring said internal resin portion.

15. The reactor according to claim 14, wherein
said internal resin portion is structured with a resin containing a ceramic filler.

16. The reactor according to claim 12, further comprising
terminal fittings each connected to an end of the wire, said terminal fittings being integrated by molding of said external resin portion.

17. The reactor according to claim 12, wherein
a sensor-use hole for accommodating a sensor for measuring a physical quantity of the reactor is provided at said external resin portion.

18. The reactor according to claim 17, wherein
said sensor-use hole is provided at said external resin portion at a portion that covers between said coil elements.

19. The reactor according to claim 16, further comprising:
a nut accommodating hole that is formed by molding of said external resin portion and that has a polygonal cross section; and
a nut that has a polygonal outer shape and that is accommodated in said nut accommodating hole, wherein
said terminal fittings each have an insertion hole for a bolt to be screwed with said nut,
said terminal fittings are each bent to thereby cover an opening of said nut accommodating hole so as to allow said bolt to be inserted through the insertion hole and to be screwed with the nut, and to thereby prevent said nut from coming off from said nut accommodating hole.

20. The reactor according to one of claims 10 and 11, wherein
said coil is structured with a continuous wire, and includes a couple portion coupling said pair of coil elements to each other, and
said couple portion projects toward an outside of a turn portion of said coil elements relative to a turn-formed face formed by the turn portion.

21. The reactor according to one of claims 10 and 11, wherein
said coil is structured with a continuous wire, and includes a couple portion coupling said pair of coil elements to each other, and
an axial direction of each of the coil elements starting from ends of the wire structuring the coil elements toward said couple portion is defined as a spiral progressing direction of each of the coil elements, and a direction perpendicular to both a paralleled direction of said pair of coil elements and an axial direction of said pair of coil elements is defined as a height direction of the coil, wherein
said pair of coil elements have their respective spiral progressing directions arranged so as to be opposite to each other's, and
said couple portion is disposed between said pair of coil elements without projecting in the height direction relative to said pair of coil elements.

22. The reactor according to claim 12, wherein
said exposed core portions of said core are each made of a powder magnetic core, wherein
a face of each of constituent members of the reactor facing a reactor fixation target is defined as an install face, wherein
said reactor further comprises a heatsink integrated with the install face of the internal resin portion, and
the install face of the heatsink and the install faces of the exposed core portions are both exposed outside said external resin portion and are flush with each other.

23. The reactor according to one of claims 10 and 11, wherein
the ends of the wire structuring said coil elements are led out sideways from said coil elements.

24. The reactor according to claim 12, further comprising
a case for accommodating an assembled product obtained by integrating the coil provided with the internal resin portion and the core, wherein
said external resin portion is formed with a potting resin injected between said case and said assembled product.

25. The reactor according to claim 12, wherein
said external resin portion includes a flange portion that projects outside an assembled product obtained by integrating the coil provided with the internal resin portion and the core, and
the flange portion is provided with a bolt hole for a bolt for fixing the reactor to a fixation target.

26. The reactor according to claim 25, wherein
said bolt hole has a metal pipe that is integrated by molding of said external resin portion.
